(19) United States
(12) Patent Application Publication
(10) Pub. No.: US 2026/0352523 A1
(43) Pub. Date: Nov. 5, 2026

(54) Link Training with Descrambler Lock Preservation During Scrambler Rate Scaling

(71) Applicant: Valens Semiconductor Ltd., Hod Hasharon (IL)

(72) Inventors: Eyran Lida, Kfar Ha-Oranim (IL); Gaby Gur Cohen, Tel-Mond (IL); Maor Alex Margalit, Petah Tikva (IL); Shai Stein, Hod Hasharon (IL); Gil Levy, Tel Aviv (IL)

(73) Assignee: Valens Semiconductor Ltd., Hod Hasharon (IL)

(21) Appl. No.: 19/345,433

(22) Filed: Sep. 30, 2025

Related U.S. Application Data
(60) Provisional application No. 63/799,802, filed on May 5, 2025.

(51) Int. Cl. H04L 25/03

(52) U.S. Cl. CPC H04L 25/03866

(57) ABSTRACT

Embodiments of a communication link training comprising generating and transmitting symbols representing a first scrambled sequence resulting from shifting a scrambler, at a first transceiver, at a first rate, wherein the first scrambled sequence is generated by inputting either all-zero or all-one input data to the scrambler. A descrambler lock is established at a second transceiver based on synchronizing the descrambler's state with the scrambler's state utilizing the symbols representing the first scrambled sequence. An increase of the first rate to a second rate is coordinated in a manner that preserves the descrambler lock, and symbols representing a second scrambled sequence resulting from shifting the scrambler at the second rate are generated and transmitted. And respective equalizers and cancellers of the second transceiver are trained based on prediction of the second scrambled sequence by the locked descrambler.

### CROSS-REFERENCE TO RELATED APPLICATIONS

This Application claims priority to U.S. Provisional Patent Application No. 63/799,802, filed May 5, 2025.

### BACKGROUND

Digital communication systems commonly employ scrambling techniques to randomize transmitted data streams, which helps maintain signal transitions for clock recovery and reduces electromagnetic interference. Scrambling typically utilizes a linear feedback shift register (LFSR) that generates a pseudo-random binary sequence based on a generator polynomial. The LFSR includes a series of shift register stages with feedback taps that implement the polynomial, producing a deterministic but pseudo-random sequence that repeats after a specific period determined by the LFSR length and polynomial configuration. At the transmitter, a scrambler may combine the LFSR output with input data through modulo-2 addition, while at the receiver, a descrambler reverses this process to recover the original data.

Communication link training procedures are employed to optimize receiver components for specific channel conditions before normal data transmission. Training may involve transmitting known or predictable patterns that allow receivers to adjust equalizer coefficients, canceller parameters, and other adaptive components. The training process may occur at various data rates, with different rates presenting different channel characteristics and impairment profiles. The duration and effectiveness of training procedures affect the time required to establish operational communication links and the quality of subsequent data transmission.

Modern communication channels exhibit various impairments that degrade signal quality and increase bit error rates. Inter-symbol interference occurs when transmitted symbols spread in time and interfere with adjacent symbols, particularly at higher data rates where symbol periods become shorter. Echo effects arise from signal reflections in the transmission medium, creating delayed versions of the transmitted signal that interfere with the direct path signal. Equalizers process received signals to compensate for channel-induced distortions and inter-symbol interference, while cancellers remove or reduce unwanted signal components such as echo. These components require training or adaptation to optimize their parameters for specific channel conditions.

Multi-lane communication systems transmit data across multiple parallel channels or lanes to increase aggregate throughput. In multi-lane configurations, inter-lane crosstalk presents an additional impairment where signals from one lane couple into adjacent lanes, creating interference. Inter-lane crosstalk cancellers may be employed to reduce this interference, but these components also require training to determine appropriate cancellation coefficients. The complexity of training increases with the number of lanes, as each lane may experience different crosstalk contributions from multiple adjacent lanes.

Moreover, communication systems often operate at multiple data rates to accommodate varying channel conditions or throughput requirements. When transitioning between rates, maintaining synchronization between transmitter and receiver components may be challenging, particularly when rate changes are substantial. Training procedures may need to be performed at each operating rate, as channel characteristics and impairment profiles may vary with data rate. Thus there is a need for efficient methods and systems for communication link training that can accommodate rate transitions and multi-lane configurations.

### SUMMARY

Some embodiments provide methods and systems for communication link training that establish and maintain descrambler lock while coordinating rate increases and training equalizers and cancellers. The embodiment addresses training challenges in both single-lane and multi-lane communication configurations. In one aspect, a method for communication link training comprises generating and transmitting symbols representing a first scrambled sequence resulting from shifting a scrambler, at a first transceiver, at a first rate, wherein the first scrambled sequence is generated by inputting either all-zero input data or all-one input data to the scrambler, resulting in either a predetermined sequence or its inverse, respectively. The method includes establishing a descrambler lock, at a second transceiver, based on synchronizing the descrambler's state with the scrambler's state utilizing the symbols representing the first scrambled sequence. The method further comprises coordinating an increase of the first rate to a second rate in a manner that preserves the descrambler lock, generating and transmitting symbols representing a second scrambled sequence resulting from shifting the scrambler at the second rate, and training respective equalizers and cancellers of the second transceiver based on prediction of the second scrambled sequence by the locked descrambler.

In another aspect, a system comprises a first transceiver comprising a scrambler configured to generate a first scrambled sequence by shifting the scrambler at a first rate, wherein the first scrambled sequence is generated by inputting either all-zero input data or all-one input data to the scrambler, resulting in either a predetermined sequence or its inverse, respectively, and transmit symbols representing the first scrambled sequence. The system includes a second transceiver comprising a descrambler, equalizers, and cancellers, wherein the second transceiver is configured to establish a descrambler lock based on synchronizing the descrambler's state with the scrambler's state utilizing the symbols representing the first scrambled sequence. The first transceiver and the second transceiver are configured to coordinate an increase of the first rate to a second rate in a manner that preserves the descrambler lock. The first transceiver is further configured to generate and transmit symbols representing a second scrambled sequence resulting from shifting the scrambler at the second rate, and the second transceiver is further configured to train the respective equalizers and cancellers based on prediction of the second scrambled sequence by the locked descrambler.

In a further aspect, a method for multi-lane communication link training comprises generating symbols representing a first scrambled sequence resulting from shifting a scrambler at a first transceiver at a first rate, wherein the first scrambled sequence is generated by inputting either all-zero input data or all-one input data to the scrambler, resulting in either a predetermined sequence or its inverse, respectively. The method includes transmitting, according to a first modulation and over a single lane, a first symbol stream representing the first scrambled sequence, and establishing a descrambler lock, at a second transceiver, based on synchronizing the descrambler's state with the scrambler's state utilizing the symbols representing the first scrambled sequence. The method further comprises coordinating an increase of the first rate to a second rate in a manner that preserves the descrambler lock, generating symbols representing a second scrambled sequence resulting from shifting the scrambler at the second rate, transmitting, according to a second modulation and over multiple lanes, the symbols representing the second scrambled sequence, and training respective equalizers, cancellers, and inter-lane crosstalk cancellers of the second transceiver based on predictions of the second scrambled sequence by the locked descrambler.

In yet another aspect, a system for multi-lane communication link training comprises a first transceiver comprising a scrambler configured to generate symbols representing a first scrambled sequence by shifting the scrambler at a first rate, wherein the first scrambled sequence is generated by inputting either all-zero input data or all-one input data to the scrambler, resulting in either a predetermined sequence or its inverse, respectively, and transmit, according to a first modulation and over a single lane, a first symbol stream representing the first scrambled sequence. The system includes a second transceiver comprising a descrambler, equalizers, cancellers, and inter-lane crosstalk cancellers, wherein the second transceiver is configured to establish a descrambler lock based on synchronizing the descrambler's state with the scrambler's state utilizing the symbols representing the first scrambled sequence. The first transceiver and the second transceiver are configured to coordinate an increase of the first rate to a second rate in a manner that preserves the descrambler lock. The first transceiver is further configured to generate symbols representing a second scrambled sequence resulting from shifting the scrambler at the second rate, and transmit, according to a second modulation and over multiple lanes, the symbols representing the second scrambled sequence. And the second transceiver is further configured to train the respective equalizers, cancellers, and inter-lane crosstalk cancellers based on predictions of the second scrambled sequence by the locked descrambler.

### BRIEF DESCRIPTION OF THE DRAWINGS

The embodiments are herein described, by way of example only, with reference to the accompanying drawings. No attempt is made to show structural details of the embodiments in more detail than is necessary for a fundamental understanding of the embodiments. In the drawings:

FIG. 1 illustrates one embodiment of a communication system implementing rate-adaptive scrambling and descrambling with synchronization maintenance;

FIG. 2 illustrates one embodiment of a method for rate adaptation with transition from self-synchronizing to synchronized descrambler operation;

FIG. 3 and FIG. 4 illustrate embodiments of methods for communication link training;

FIG. 5 illustrates one embodiment of a system comprising a first transceiver and a second transceiver configured to coordinate rate increases while preserving descrambler lock;

FIG. 6 illustrates one embodiment of a method for multi-lane communication link training;

FIG. 7 illustrates one embodiment of a method for selective bit transmission with constant-rate scrambler; and

FIG. 8A and FIG. 8B are schematic illustrations of possible embodiments of computers.

### DETAILED DESCRIPTION

In one embodiment, a communication system implements a process for transitioning from self-synchronizing descrambler operation to synchronized descrambler operation while maintaining synchronization throughout the transition. The process may include multiple stages, where each stage may be verified before proceeding to the next stage. In the first stage, a transmitter may process all-zero input data, or all-one input data, using a scrambler that utilizes a linear feedback shift register (LFSR) that shifts at a first rate. When processing all-zero input data, the scrambler's output is the LFSR sequence itself, unmodified by data content, while when processing all-one input data, the scrambler's output is the inverse of the LFSR sequence. The receiver may begin operation with its descrambler, also shifting at the first rate, in self-synchronizing mode, where the descrambler uses a feedback shift register that updates its state based on previously received bits. This feedback mechanism may allow the descrambler to reconstruct the transmitter's LFSR sequence or its inverse within an acceptable bit error rate in the received data stream, ultimately recovering the original all-zero or all-one input data.

The self-synchronization method may be employed to achieve the initial rough synchronization. In one embodiment, the operation in the self-synchronizing mode comprises using a feedback shift register that updates its state based on previously received bits to reconstruct the transmitter's LFSR sequence within an acceptable bit error rate in the received data stream. Even if the initial state is unknown or incorrect, the feedback mechanism of the self-synchronizing descrambler will, under the condition of an acceptable bit error rate in the received data stream, cause the receiver's LFSR state to converge towards the transmitter's LFSR state. The duration required for this convergence depends on the LFSR length and the channel conditions, where longer LFSRs may necessitate longer periods for convergence.

After achieving synchronization in self-synchronizing mode, the receiver may switch its descrambler to operate in synchronized mode. To verify successful synchronization in the synchronized mode, the receiver may compare a predicted sequence of bits generated by its local LFSR with the corresponding bits received from the transmitter. The number of bits used for comparison may be greater than the length of the LFSR to provide additional verification confidence. In some LFSR structures, this verification process may enable the receiver to detect and correct for bit polarity inversion in the decoded transmitter sequence. If synchronization verification fails, the receiver may revert to self-synchronizing mode and restart the synchronization process. The restart process may include adjusting parameters such as equalization settings, cancellation parameters, or synchronization verification thresholds. Once synchronized, the receiver may use the predicted LFSR sequence as a reference pattern for additional training of its equalizers and cancellers at the first rate. This training process, based on the predicted LFSR sequence, may continue until it achieves a predetermined level of equalization and cancellation performance. The predetermined performance level may be selected based on various factors such as the communication channel characteristics, desired bit error rate, or system requirements.

The system may maintain all-zero input data at the transmitter for a predetermined stabilization period after switching to synchronized mode before performing synchronization verification. The receiver may signal its readiness to the transmitter before transitioning between operating modes.

After confirming proper synchronization in synchronized mode, the system may proceed with rate adjustment by increasing the shifting rate of both the scrambler and descrambler from the first rate to a second rate while maintaining synchronization. Since the channel characteristics may change significantly at the higher rate, the receiver may perform a second training phase to optimize its equalizers and cancellers for operation at the second rate. The receiver is configured to achieve a predetermined level of equalization and cancellation performance at the second rate before the transmitter processes arbitrary input data. The receiver may verify successful rate adjustment by comparing predicted bits generated at the second rate with corresponding received bits from the transmitter. The verification process may use a sufficient number of bits to validate proper rate adjustment while maintaining synchronization.

Following successful rate adjustment and training verification at the second rate, the system may coordinate the transition to the arbitrary input data, which may occur at a point in the LFSR sequence determined based on various factors, such as a predetermined fixed point, current operating conditions, or a negotiated agreement between the transmitter and receiver. The system transitions from using a specific training sequence (all-zero or all-one input data) to processing arbitrary input data, where “arbitrary input data” may refer to any possible sequence or pattern of input bits that may occur during operation. This arbitrary input data encompasses all possible bit combinations and patterns, including but not limited to: sequences containing any mixture of ones and zeros, repetitive patterns, random or pseudorandom sequences, framed data packets, encoded data streams, or any other data patterns that may be presented to the transmitter during normal operation. The transition from the all-zero or all-one input data to the arbitrary input data represents the shift from a controlled, predetermined pattern used for synchronization and training purposes to essentially unrestricted normal operation where the input data is determined by user or system requirements rather than by training needs. The system maintains its synchronization and trained parameters while processing this arbitrary input data, having established these during the training phase.

In one embodiment, a system includes a transmitter comprising a scrambler that utilizes a linear feedback shift register (LFSR) that shifts at a first rate, wherein when the scrambler receives either all-zero input data or all-one input data, the transmitter sends a data stream at a first transmitted data rate exhibiting a periodic pattern corresponding to either a predetermined LFSR sequence or its inverse, respectively. The system further includes a receiver configured to receive the data stream at the first transmitted data rate, descramble the data stream utilizing a descrambler that shifts at the first rate, wherein the descrambler operating in a self-synchronizing mode, synchronize an LFSR in the descrambler to be in the same state as the LFSR in the scrambler at the corresponding point in the data stream, subsequently switch the descrambler to operate in a synchronized mode, verify successful synchronization based on comparing predicted bits with the received bits, and train the receiver's equalizers and cancellers utilizing its synchronized descrambler to predict incoming transmitter symbols. The transmitter and receiver are further configured to increase both the shifting rate of the scrambler and descrambler from the first rate to a second rate and the transmitted data rate from the first transmitted data rate to a second transmitted data rate, while the descrambler maintains synchronization with the scrambler. The receiver is further configured to train its equalizers and cancellers at the second transmitted data rate while maintaining synchronization in the synchronized mode, and the transmitter is further configured to subsequently process arbitrary input data at the second transmitted data rate. When processing all-zero input data, the scrambler's output matches the LFSR sequence itself, as the input data does not modify the sequence. When processing all-one input data, the scrambler's output produces the inverse of the LFSR sequence, as each ‘1’ input bit inverts the corresponding LFSR output bit. Both cases produce predictable periodic patterns that can be used for training and synchronization purposes.

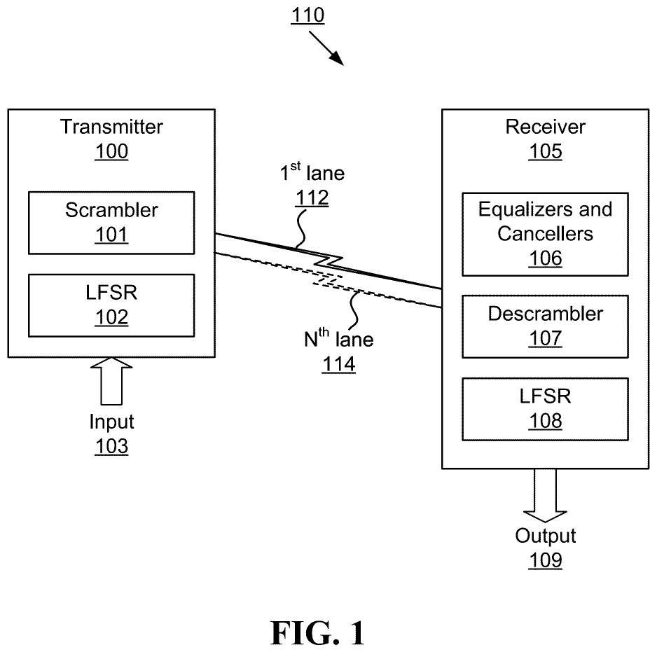

FIG. 1 illustrates one embodiment of a communication system 110 implementing rate-adaptive scrambling and descrambling with synchronization maintenance. The transmitter 100 comprises a scrambler 101 coupled to an LFSR 102. Input 103 is fed into the scrambler 101, which processes either all-zero or all-one input data to generate a data stream containing the LFSR sequence or its inverse. This data stream may be transmitted over one or more lanes, shown as 1st lane 112 through Nth lane 114. The receiver 105 includes equalizers and cancellers 106 for signal conditioning, a descrambler 107, and an internal LFSR 108. The descrambler 107 initially operates in self-synchronizing mode to achieve LFSR state alignment, then switches to synchronized mode for maintaining synchronization. Output 109 delivers the descrambled data. The system may coordinate rate transitions from the first to the second rate while maintaining synchronization, and subsequently process arbitrary input data with the equalizers and cancellers 106 trained using the predictable LFSR sequence patterns.

In some embodiments of the system, the receiver may be configured to verify synchronization in the synchronized mode by comparing a predicted sequence of at least a predetermined number of bits generated by the descrambler with corresponding bits received from the transmitter, wherein the predetermined number of bits exceeds a length of the LFSR. The predetermined number of bits used for verification may provide enhanced confidence in the synchronization status by evaluating multiple cycles of the LFSR sequence. This extended verification process may help detect potential phase errors, polarity inversions, or other synchronization anomalies that could remain undetected with shorter verification sequences. The system may implement various comparison algorithms, which may include bit-by-bit comparison, cumulative error counting, or statistical confidence measures based on the matching rate between predicted and received bits. The verification threshold may be dynamically adjusted based on channel conditions, communication requirements, or historical performance data. In some embodiments, the verification process may implement error tolerance levels that may allow for acceptable bit error rates while still confirming overall synchronization integrity.

In certain aspects of the system, the receiver may be configured to verify successful rate adjustment by comparing at least a predetermined number of predicted bits generated at the second rate with corresponding received bits from the transmitter received at the second transmitted data rate, wherein the first transmitted data rate corresponds to transmission at a first symbol rate and the second transmitted data rate corresponds to transmission at a second symbol rate, and wherein the first transmitted data rate and the first symbol rate are at least 4 times, 16 times, 32 times, 64 times, or 128 times slower than the second transmitted data rate and the second symbol rate, respectively. These rate differences may be selected to achieve substantial performance improvements while establishing sufficient robustness at the slower rate to support the subsequent transition. The verification process at the second rate may account for potential changes in channel characteristics, inter-symbol interference patterns, or noise profiles that may vary with the operating rate. The system may implement adaptive thresholds for verification success that may consider factors such as the magnitude of the rate increase, channel stability measurements, or historical performance metrics. In some implementations, progressive rate increases may be employed, where intermediate rates may be verified before reaching the final second rate. Moreover, these rate differences may apply to both the transmitted data rate and the corresponding symbol rate at which symbols are transmitted through the channel. The symbol rate increase affects the receiver's ability to process incoming symbols, while the data rate increase determines the overall throughput. The verification process at the second rate accounts for changes in both symbol timing and data throughput, and when modulation remains constant these rates scale proportionally. The system may implement adaptive thresholds for verification success that consider both the symbol rate increase affecting timing recovery and the data rate increase affecting channel utilization.

Optionally, the transmitter and receiver may be configured to coordinate transition to arbitrary input data at a point in the LFSR sequence determined based on at least one of: a predetermined fixed point, current operating conditions, or a negotiated agreement between the transmitter and receiver. The transition point selection may optimize system performance when shifting from known reference data to arbitrary input data occurs under favorable conditions. A predetermined fixed point may provide simplicity and predictability to the transition process, while current operating conditions-based selection may allow for adaptive timing that responds to channel quality, error rates, or convergence metrics. Negotiated agreements between transmitter and receiver may enable dynamic adjustments based on bidirectional feedback and system-specific requirements. The coordination process may involve explicit signaling protocols, implicit detection mechanisms, or hybrid approaches that combine multiple selection criteria. The system may implement verification steps to confirm both the transmitter and receiver have identified the same transition point, which may help prevent misalignment between the two systems' operating modes.

In some embodiments of the system, operation in the synchronized mode may include generating predicted bits using a local LFSR in the descrambler configured to match the state of the transmitter's LFSR. The local LFSR in the descrambler may operate autonomously to generate the predicted bit stream by maintaining internal state information that mirrors the transmitter's LFSR progression. The configuration to match the transmitter's LFSR state may be achieved through initial state alignment during synchronization, with subsequent maintenance through synchronized clock transitions. The system may implement state verification mechanisms that periodically compare the local LFSR output with actual received data to evaluate continued alignment. In some embodiments, the local LFSR may incorporate error detection capabilities that may trigger resynchronization procedures when accumulated errors exceed threshold levels.

Additionally, the synchronized mode may further include periodic error monitoring and correction using feedback from the data stream while maintaining primary synchronization through the local LFSR. The periodic error monitoring function may provide ongoing quality assessment of the synchronization status while potentially reducing error accumulation that could lead to desynchronization. The feedback mechanism from the received data stream may supply correction signals that can adjust the local LFSR's operation while maintaining the primary synchronization through local generation. This dual-approach system may offer enhanced robustness by combining the efficiency of local LFSR operation with the accuracy assurance achieved through periodic feedback verification. The error monitoring frequency may be adjusted based on channel conditions, anticipated data rates, or system performance requirements. Correction mechanisms may range from minor state adjustments to more comprehensive resynchronization procedures, with selection criteria possibly determined by the nature and magnitude of detected errors.

In certain aspects, training the equalizers and cancellers may include using the LFSR sequence or its inverse as a reference pattern for adaptation. The specific types of equalizers and cancellers employed depend on the characteristics of the communication channel and the impairments to be mitigated. The following are some common examples of equalizers and cancellers: (i) Linear Equalizers are relatively simple equalizers that use a finite impulse response (FIR) filter to compensate for linear distortions in the channel. (ii) Zero-Forcing (ZF) Equalizer aims to eliminate inter-symbol interference (ISI) by inverting the channel response; however, it can enhance noise. (iii) Minimum Mean Square Error (MMSE) Equalizer is a more robust linear equalizer that minimizes the mean squared error between the transmitted and received signals, considering both ISI and noise. (iv) Decision Feedback Equalizer (DFE) is a non-linear equalizer that uses past decisions to cancel out ISI from future symbols; DFEs are generally more effective than linear equalizers for channels with severe ISI but can suffer from error propagation if incorrect decisions are fed back. (v) Adaptive Equalizers can adjust their coefficients over time to adapt to changing channel conditions; they typically use algorithms such as Least Mean Squares (LMS) or Recursive Least Squares (RLS) to update the filter coefficients. (vi) Echo Canceller is used to remove echoes that can occur in communication channels, especially in scenarios with reflections; echo cancellers typically use adaptive filtering techniques to estimate and subtract the echo from the received signal. Or (vii) Interference Canceller that are designed to remove specific types of interference, such as narrowband interference or co-channel interference in wireless systems.

In some embodiments, upon failing to verify successful synchronization or successful rate adjustment, the receiver may be configured to revert to the self-synchronizing mode and restart the synchronization process. The recovery procedure may implement an automatic rollback mechanism that restores the system to a known operational state when synchronization failures are detected, which may provide an inherently robust starting point for re-establishing synchronization. The restart process may include system diagnostics that evaluate the cause of failure, which may inform parameter adjustments for the subsequent synchronization attempt. The recovery mechanism may implement timeout periods or retry limitations to control recovery attempts under persistent failure conditions. In some embodiments, the system may log failure events and recovery outcomes for diagnostic analysis or adaptive threshold adjustment.

Optionally, restarting the synchronization process may include adjusting at least one of equalization parameters or cancellation parameters. The parameter adjustment during restart may optimize the synchronization process based on information gained from the previous failure. Equalization parameters may be modified to better address channel characteristics revealed during the failed attempt, such as increasing tap lengths to handle longer multipath delays or adjusting coefficients to compensate for frequency-dependent distortions. Cancellation parameters may be tuned to more effectively mitigate interference patterns identified during the failure analysis. The adjustment strategy may include incremental modifications that gradually adapt to channel conditions, or more substantial changes that address fundamental mismatches between system configuration and operating environment. Parameter modification may be applied selectively based on performance indicators that identify which specific aspects of signal processing require enhancement for successful synchronization.

In certain aspects of the system, the receiver may be further configured to signal readiness to the transmitter before the switch from the self-synchronizing mode to the synchronized mode. The readiness signaling mechanism may coordinate state transitions between transmitter and receiver during mode changes. The signal may convey the receiver's assessment of synchronization quality, convergence of adaptation algorithms, or achievement of performance thresholds necessary for reliable synchronized mode operation. The signaling protocol may include explicit acknowledgments, implicit feedback through data pattern recognition, or hybrid approaches that combine multiple communication methods. The readiness criteria may be defined by specific metrics such as bit error rate thresholds, equalizer convergence indicators, or phase stability measurements. The transmitter may implement corresponding verification procedures to confirm readiness signals have been correctly received before proceeding with the mode switch, which may include timeout mechanisms or alternative transition protocols for scenarios where readiness signals are not successfully communicated.

In some embodiments of the system, prior to the increase of the shifting rate and transmitted data rate, the transmitter may be configured to transmit the data stream over a single lane at the first transmitted data rate which corresponds to a first symbol rate, and after the increase of the shifting rate and transmitted data rate, the transmitter may be configured to transmit the data stream over multiple lanes at the second transmitted data rate which corresponds to a second symbol rate while maintaining synchronization in the synchronized mode, and wherein the first symbol rate is at least 4 times, 16 times, 32 times, 64 times, or 128 times slower than the second symbol rate. In some embodiments, the system initially establishes synchronization on a single lane at a lower symbol rate before transitioning to multi-lane operation at a higher symbol rate. The first transmitted data rate corresponds to the first symbol rate at which symbols traverse the single lane, while the second transmitted data rate corresponds to the second symbol rate distributed across multiple lanes. This embodiment simplifies the initial synchronization process by avoiding inter-lane crosstalk effects during the synchronization phase at the lower symbol rate. Once synchronization is established and the symbol rate is increased, the system expands to multiple lanes while maintaining the established synchronization.

After transitioning to multiple lanes, the receiver may be configured to predict expected received bits for each lane based on the synchronized LFSR state, and verify successful synchronization across all lanes by comparing the predicted bits with received bits on each respective lane. To verify synchronization across all lanes, the receiver may use its synchronized LFSR state to predict the expected bit sequence for each lane, taking into account how the transmitter distributes the scrambled sequence across multiple lanes and whether the original input was all-zeros or all-ones. By comparing predicted versus received bits on each lane, the receiver can verify that synchronization has been maintained across the transition to multi-lane operation and that the data is being properly distributed across the lanes.

Additionally, the receiver may be further configured to train inter-lane crosstalk cancellers based on the input data. After verifying synchronization across all lanes, the receiver leverages the predictable nature of the scrambled sequence to train its inter-lane crosstalk cancellers, as it can predict the expected data on each lane based on the synchronized descrambler state.

Alternatively, the transmitter may be configured to transmit only on a single lane both before and after the increase of the shifting rate and transmitted data rate, and wherein the receiver may be configured to maintain synchronization on the single lane during and after the increase from the first rate to the second rate and from the first transmitted data rate to the second transmitted data rate. In some embodiments, the system operates on a single lane while changing the modes and implementing the rate increase. The receiver maintains synchronization on the single lane during and after the increase from the first rate to the second rate. This continuous maintenance of synchronization allows the system to continue operating even as it adapts to the increased data rate. The system achieves this by coordinating the rate change between transmitter and receiver while preserving the LFSR state relationships, ensuring that the descrambler remains correctly synchronized with the scrambler through the rate transition process.

In another embodiment, a system includes a transmitter configured to operate a scrambler that utilizes a linear feedback shift register (LFSR) that shifts at a first rate, wherein when the scrambler receives either all-zero input data or all-one input data, the transmitter outputs a data stream at a first transmitted data rate exhibiting a periodic pattern corresponding to either a predetermined LFSR sequence or its inverse, respectively. The system further includes a receiver configured to receive the data stream at the first transmitted data rate, operate a descrambler that shifts at the first rate in a self-synchronizing mode at least until the descrambled output data stream exhibits the predetermined LFSR sequence or its inverse, which indicates that the receiver's internal LFSR state is synchronized with the transmitter's LFSR state, subsequently switch the descrambler to operate in a synchronized mode in which a local LFSR generates predicted bits that are manifested in an output data stream matching the predetermined LFSR sequence or its inverse, and verify successful synchronization based on comparing predicted bits with the received bits. The transmitter and receiver are further configured to increase both the shifting rate of the scrambler and descrambler from the first rate to a second rate and the transmitted data rate from the first transmitted data rate to a second transmitted data rate, while the descrambler maintains synchronization with the scrambler, and the transmitter is further configured to subsequently process arbitrary input data at the second transmitted data rate. The automatic detection of LFSR pattern matching may provide clear indication of synchronization achievement. The descrambler may autonomously determine synchronization status by monitoring its output data stream for emergence of the expected periodic pattern, which may eliminate reliance on external signaling or auxiliary verification mechanisms for initial synchronization detection. Optionally, the state synchronization between transmitter and receiver LFSRs may be confirmed through pattern recognition.

In some embodiments, the receiver may be further configured to train its equalizers and cancellers at the first transmitted data rate utilizing the synchronized descrambler to predict the received bits, wherein training the equalizers and cancellers may include using the known LFSR sequence or its inverse as a reference pattern for adaptation, and wherein the first transmitted data rate corresponds to a first symbol rate that is at least 4 times, 16 times, 32 times, 64 times, or 128 times slower than a second symbol rate corresponding to the second transmitted data rate. Training at the lower first transmitted data rate, which corresponds to a lower first symbol rate, may provide opportunity for equalizer and canceller convergence under more favorable channel conditions. The lower symbol rate may allow for higher signal-to-noise ratios or simpler distortion characteristics, facilitating initial parameter adaptation. The synchronized descrambler may supply prediction references for training algorithms at the first symbol rate, which may accelerate convergence rates, and may establish baseline performance levels before transitioning to the higher second symbol rate for increased throughput conditions.

Optionally, the receiver may be further configured to train its equalizers and cancellers at the second transmitted data rate while maintaining synchronization in the synchronized mode, wherein training the equalizers and cancellers may include using the known LFSR sequence or its inverse as a reference pattern for adaptation. Continued training at the second transmitted data rate may address channel characteristic changes resulting from increased data throughput. The higher transmitted data rate may introduce different interference patterns, timing sensitivities, or frequency response variations that require updated equalizer and canceller parameters. The maintained synchronization may provide continuous reference pattern availability throughout the adaptation process, enabling real-time adjustment to evolving channel conditions. The reference pattern may help distinguish between legitimate channel effects and desynchronization errors.

In certain aspects, the receiver may be further configured to signal readiness to the transmitter before the switch from the self-synchronizing mode to the synchronized mode, and the transmitter and receiver may be configured to coordinate transition to arbitrary input data at the second transmitted data rate at a point in the LFSR sequence determined based on at least one of: a predetermined fixed point, current operating conditions, or a negotiated agreement between the transmitter and receiver. The combined coordination mechanisms may provide flexible control over operational mode transitions. The readiness signaling may confirm receiver preparation before critical state changes, while the selectable transition approaches may optimize timing based on specific system conditions or requirements. These coordination methods may work together to manage both initial synchronization achievements and subsequent shifts to normal data processing modes. The multiple coordination options may accommodate different deployment scenarios or performance optimization techniques.

In some embodiments, prior to the increase of the shifting rate and transmitted data rate, the transmitter may be configured to transmit the data stream over a single lane at the first transmitted data rate, and after the increase of the shifting rate and transmitted data rate, the transmitter may be configured to transmit the data stream over multiple lanes at the second transmitted data rate while maintaining synchronization in the synchronized mode. Beginning synchronization on a single lane may simplify initial state alignment by eliminating inter-lane crosstalk and distribution complexity. It may also provide cleaner channel conditions for establishing robust synchronization before expanding to multiple lanes. Following rate increase and lane expansion, the maintained synchronization may allow predictable data distribution across lanes, which may balance synchronization reliability with throughput optimization.

After transitioning to multiple lanes, the receiver may be configured to predict expected received bits for each lane based on the synchronized LFSR state, and verify successful synchronization across all lanes by comparing the predicted bits with received bits on each respective lane, and wherein the receiver may be further configured to train inter-lane crosstalk cancellers based on the input data. Lane-by-lane verification may confirm proper data distribution and synchronization preservation across multiple transmission paths. The known LFSR sequence enables prediction of expected data on each lane, facilitating detection of lane-specific issues or cross-channel interference. The predictable reference patterns may enhance crosstalk canceller training by providing clear baseline signals for isolating interference characteristics between adjacent lanes, and the comprehensive verification may validate multi-lane operation integrity.

Alternatively, the transmitter may be configured to transmit only on a single lane both before and after the increase of the shifting rate and transmitted data rate, and wherein the receiver may be configured to maintain synchronization on the single lane during and after the increase from the first rate to the second rate and from the first transmitted data rate to the second transmitted data rate. Single-lane operation may provide simplified synchronization maintenance throughout rate transitions. The consistent channel characteristics inherent to single-lane transmission may minimize variables affecting synchronization stability during throughput changes, which may reduce complexity by avoiding lane distribution algorithms or inter-lane synchronization challenges. The maintained synchronization across rate transitions may offer reliable operation while achieving higher throughput within single-lane constraints.

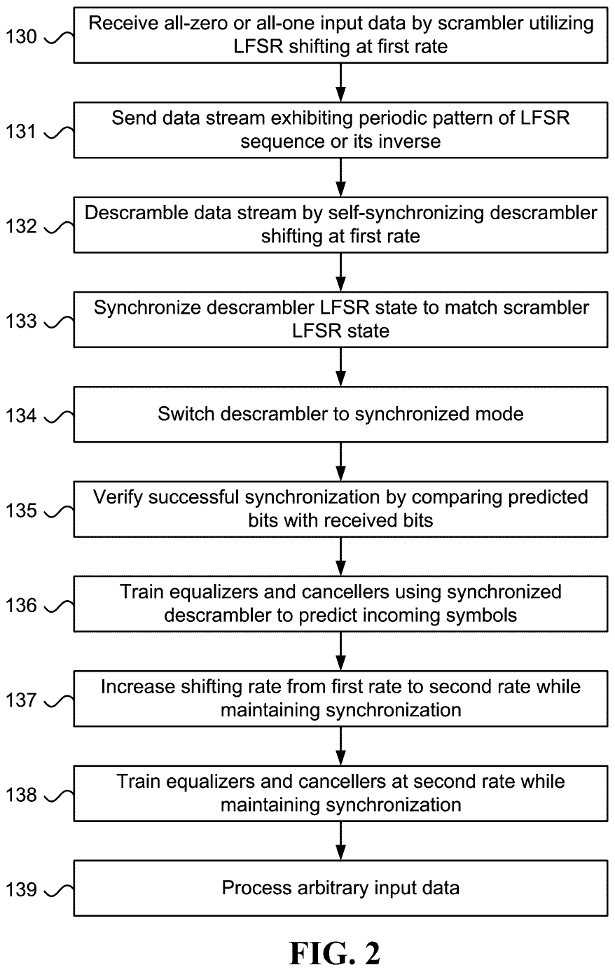

FIG. 2 illustrates one embodiment of a method for rate adaptation with transition from self-synchronizing to synchronized descrambler operation. The method includes the following steps. In step 130, receive all-zero or all-one input data by scrambler utilizing LFSR shifting at first rate. In step 131, send data stream at first transmitted data rate exhibiting periodic pattern of LFSR sequence or its inverse. In step 132, descramble data stream by self-synchronizing descrambler shifting at first rate. In step 133, synchronize descrambler LFSR state to match scrambler LFSR state. In step 134, switch descrambler to synchronized mode. In step 135, verify successful synchronization by comparing predicted bits with received bits. In step 136, train equalizers and cancellers using synchronized descrambler to predict incoming symbols. In step 137, increase both shifting rate from first rate to second rate and transmitted data rate from first transmitted data rate to second transmitted data rate while maintaining synchronization. In step 138, train equalizers and cancellers at second transmitted data rate while maintaining synchronization. And in step 139, process arbitrary input data at second transmitted data rate.

In one embodiment, a method includes receiving, by a scrambler of a transmitter, which utilizes a linear feedback shift register (LFSR) shifting at a first rate, either all-zero input data or all-one input data, sending a data stream at a first transmitted data rate exhibiting a periodic pattern corresponding to either a predetermined LFSR sequence or its inverse, respectively, descrambling the data stream, by a descrambler of a receiver, which shifts at the first rate, wherein the descrambler operating in a self-synchronizing mode, synchronizing an LFSR in the descrambler to be in the same state as the LFSR in the scrambler at the corresponding point in the data stream, switching the descrambler to operate in a synchronized mode, verifying successful synchronization based on comparing predicted bits with the received bits, training equalizers and cancellers utilizing its synchronized descrambler to predict the incoming transmitter symbols, increasing both the shifting rate of the scrambler and descrambler from the first rate to a second rate and the transmitted data rate from the first transmitted data rate to a second transmitted data rate, while maintaining synchronization between the descrambler and scrambler, training the receiver's equalizers and cancellers at the second transmitted data rate while maintaining synchronization in the synchronized mode, and subsequently processing arbitrary input data at the transmitter at the second transmitted data rate.

In certain aspects of the method, the verifying successful synchronization in the synchronized mode may include comparing a predicted sequence of at least a predetermined number of bits generated by the descrambler with corresponding bits received from the transmitter, wherein the predetermined number of bits exceeds a length of the LFSR.

Optionally, the method may include verifying successful rate adjustment by comparing at least a predetermined number of predicted bits generated at the second rate with corresponding received bits from the transmitter received at the second transmitted data rate, wherein the first transmitted data rate corresponds to transmission at a first symbol rate and the second transmitted data rate corresponds to transmission at a second symbol rate, and wherein the first transmitted data rate and the first symbol rate are at least 4 times, 16 times, 32 times, 64 times, or 128 times slower than the second transmitted data rate and the second symbol rate, respectively. The verification process confirms that both data rate and corresponding symbol rate transitions have been successfully completed. The symbol rate verification ensures proper symbol timing recovery, while the data rate verification confirms throughput targets are met. These related verifications confirm that the rate transition has been successful at both the physical symbol level and the logical data level.

In some embodiments, the processing arbitrary input data may include coordinating transition to the arbitrary input data at the second transmitted data rate at a point in the LFSR sequence determined based on at least one of: a predetermined fixed point, current operating conditions, or a negotiated agreement between the transmitter and receiver. Additionally, the training of the equalizers and cancellers may include using the known LFSR sequence or its inverse as a reference pattern for adaptation.

In certain aspects of the method, prior to increasing the shifting rate and transmitted data rate, the method may include sending the data stream over a single lane at the first transmitted data rate which corresponds to a first symbol rate, and after increasing the shifting rate and transmitted data rate, sending the data stream over multiple lanes at the second transmitted data rate which corresponds to a second symbol rate, wherein the first symbol rate is at least 4 times, 16 times, 32 times, 64 times, or 128 times slower than the second symbol rate, and further including training inter-lane crosstalk cancellers based on the received data stream while maintaining synchronization in the synchronized mode. The method transitions from single-lane operation at a lower symbol rate to multi-lane operation at a higher symbol rate. The symbol rate increase determines how fast symbols are processed across the multiple lanes, impacting the operating speed requirements for the inter-lane crosstalk cancellers. The maintained synchronization enables effective training throughout the symbol rate transition.

Optionally, the method may further include, after the sending of the data stream over multiple lanes, predicting expected received bits for each lane based on the synchronized LFSR state, and verifying successful synchronization across all lanes by comparing the predicted bits with received bits on each respective lane. Alternatively, the sending of the data stream may include sending over a single lane both before and after increasing the shifting rate and transmitted data rate, and the maintaining of synchronization may include maintaining synchronization on the single lane during and after the increasing from the first rate to the second rate and from the first transmitted data rate to the second transmitted data rate.

The following numbered embodiments are non-limiting embodiments that may be combined with other compatible embodiments described herein and/or may be combined with, or refer to, any compatible claims.
1.In one embodiment, system, comprising: a transmitter comprising a scrambler that utilizes a linear feedback shift register (LFSR) that shifts at a first rate, wherein when the scrambler receives either all-zero input data or all-one input data, the transmitter sends a data stream at a first transmitted data rate exhibiting a periodic pattern corresponding to either a predetermined LFSR sequence or its inverse, respectively; and a receiver configured to: receive the data stream at the first transmitted data rate, descramble the data stream utilizing a descrambler that shifts at the first rate, wherein the descrambler operating in a self-synchronizing mode, synchronize an LFSR in the descrambler to be in the same state as the LFSR in the scrambler at the corresponding point in the data stream, subsequently switch the descrambler to operate in a synchronized mode, verify successful synchronization based on comparing predicted bits with the received bits, and train the receiver's equalizers and cancellers utilizing its synchronized descrambler to predict incoming transmitter symbols; wherein the transmitter and receiver are further configured to increase both the shifting rate of the scrambler and descrambler from the first rate to a second rate and the transmitted data rate from the first transmitted data rate to a second transmitted data rate, while the descrambler maintains synchronization with the scrambler; wherein the receiver is further configured to train its equalizers and cancellers at the second transmitted data rate while maintaining synchronization in the synchronized mode; and wherein the transmitter is further configured to subsequently process arbitrary input data at the second transmitted data rate.
2. The system of embodiment 1, wherein the receiver is configured to verify synchronization in the synchronized mode by comparing a predicted sequence of at least a predetermined number of bits generated by the descrambler with corresponding bits received from the transmitter, wherein the predetermined number of bits exceeds a length of the LFSR.
3. The system of any one of embodiments 1-2, wherein the receiver is configured to verify successful rate adjustment by comparing at least a predetermined number of predicted bits generated at the second rate with corresponding received bits from the transmitter received at the second transmitted data rate; and wherein the first transmitted data rate is at least 4 times, 16 times, 32 times, 64 times, or 128 times slower than the second transmitted data rate.
4. The system of any one of embodiments 1-3, wherein the transmitter and receiver are configured to coordinate transition to arbitrary input data at a point in the LFSR sequence determined based on at least one of: a predetermined fixed point, current operating conditions, or a negotiated agreement between the transmitter and receiver.
5. The system of any one of embodiments 1-4, wherein operation in the synchronized mode comprises generating predicted bits using a local LFSR in the descrambler configured to match the state of the transmitter's LFSR.
6. The system of embodiment 5, wherein the synchronized mode further comprises periodic error monitoring and correction using feedback from the data stream while maintaining primary synchronization through the local LFSR.
7. The system of any one of embodiments 1-6, wherein training the equalizers and cancellers comprises using the LFSR sequence or its inverse as a reference pattern for adaptation.
8. The system of any one of embodiments 1-7, wherein upon failing to verify successful synchronization or successful rate adjustment, the receiver is configured to revert to the self-synchronizing mode and restart the synchronization process.
9. The system of embodiment 8, wherein restarting the synchronization process comprises adjusting at least one of equalization parameters or cancellation parameters.
10. The system of any one of embodiments 1-9, wherein the receiver is further configured to signal readiness to the transmitter before the switch from the self-synchronizing mode to the synchronized mode.
11. The system of any one of embodiments 1-10, wherein prior to the increase of the shifting rate and transmitted data rate, the transmitter is configured to transmit the data stream over a single lane at the first transmitted data rate, and after the increase of the shifting rate and transmitted data rate, the transmitter is configured to transmit the data stream over multiple lanes at the second transmitted data rate while maintaining synchronization in the synchronized mode.
12. The system of embodiment 11, wherein after transitioning to multiple lanes, the receiver is configured to: predict expected received bits for each lane based on the synchronized LFSR state, and verify successful synchronization across all lanes by comparing the predicted bits with received bits on each respective lane.
13. The system of any one of embodiments 11-12, wherein the receiver is further configured to train inter-lane crosstalk cancellers based on the input data.
14. The system of any one of embodiments 1-10, wherein the transmitter is configured to transmit only on a single lane both before and after the increase of the shifting rate and transmitted data rate; and wherein the receiver is configured to maintain synchronization on the single lane during and after the increase from the first rate to the second rate and from the first transmitted data rate to the second transmitted data rate.
15. In one embodiment, method, comprising: receiving, by a scrambler of a transmitter, which utilizes a linear feedback shift register (LFSR) shifting at a first rate, either all-zero input data or all-one input data; sending a data stream at a first transmitted data rate exhibiting a periodic pattern corresponding to either a predetermined LFSR sequence or its inverse, respectively; descrambling the data stream, by a descrambler of a receiver, which shifts at the first rate, wherein the descrambler operating in a self-synchronizing mode; synchronizing an LFSR in the descrambler to be in the same state as the LFSR in the scrambler at the corresponding point in the data stream; switching the descrambler to operate in a synchronized mode; verifying successful synchronization based on comparing predicted bits with the received bits; training equalizers and cancellers utilizing its synchronized descrambler to predict the incoming transmitter symbols; increasing both the shifting rate of the scrambler and descrambler from the first rate to a second rate and the transmitted data rate from the first transmitted data rate to a second transmitted data rate, while maintaining synchronization between the descrambler and scrambler; training the receiver's equalizers and cancellers at the second transmitted data rate while maintaining synchronization in the synchronized mode; and subsequently processing arbitrary input data at the transmitter at the second transmitted data rate.
16. The method of embodiment 15, wherein: (i) the verifying successful synchronization in the synchronized mode comprises comparing a predicted sequence of at least a predetermined number of bits generated by the descrambler with corresponding bits received from the transmitter, wherein the predetermined number of bits exceeds a length of the LFSR; or (ii) the verifying successful rate adjustment comprises comparing at least a predetermined number of predicted bits generated at the second rate with corresponding received bits from the transmitter received at the second transmitted data rate; and wherein the first transmitted data rate is at least 4 times, 16 times, 32 times, 64 times, or 128 times slower than the second transmitted data rate.
17. The method of any one of embodiments 15-16, wherein at least one of: (i) the processing arbitrary input data comprises coordinating transition to the arbitrary input data at the second transmitted data rate at a point in the LFSR sequence determined based on at least one of: a predetermined fixed point, current operating conditions, or a negotiated agreement between the transmitter and receiver; or (ii) the training of the equalizers and cancellers comprises using the known LFSR sequence or its inverse as a reference pattern for adaptation.
18. The method of any one of embodiments 15-17, wherein prior to increasing the shifting rate and transmitted data rate, sending the data stream over a single lane at the first transmitted data rate, and after increasing the shifting rate and transmitted data rate, sending the data stream over multiple lanes at the second transmitted data rate; and further comprising: predicting expected received bits for each lane based on the synchronized LFSR state, verifying successful synchronization across all lanes by comparing the predicted bits with received bits on each respective lane, and optionally training inter-lane crosstalk cancellers based on the received data stream while maintaining synchronization in the synchronized mode.
19. The method of any one of embodiments 15-17, wherein the sending of the data stream comprises sending over a single lane both before and after increasing the shifting rate and transmitted data rate; and the maintaining of synchronization comprises maintaining synchronization on the single lane during and after the increasing from the first rate to the second rate and from the first transmitted data rate to the second transmitted data rate.

In one embodiment, a system includes a transmitter configured to send symbols to a receiver at a first throughput, wherein the transmitter comprises a scrambler that utilizes a linear feedback shift register (LFSR) shifting at a first rate, wherein the LFSR generates an LFSR sequence. The system further includes a receiver comprising a descrambler utilizing an LFSR shifting at the first rate, equalizers, and cancellers, wherein the receiver is configured to lock its descrambler to generate a known LFSR sequence matching the LFSR sequence or its inverse. The transmitter and receiver are configured to coordinate an increase in the rate of shifting of their respective LFSRs from the first rate to a second rate while maintaining the descrambler locked and maintaining the known LFSR sequence, thereby increasing the throughput of sending symbols from the transmitter to the receiver to a second throughput. The receiver is further configured to use the known LFSR sequence as a reference pattern to train the equalizers and cancellers at the second rate at a training speed faster than possible without knowing the LFSR sequence.

In some embodiments of the system, the receiver may be configured to lock its descrambler by operating the descrambler in a self-synchronizing mode to achieve initial synchronization with the scrambler while receiving the symbols at the first throughput, switching the descrambler to operate in a synchronized mode while maintaining synchronization, and verifying successful synchronization by comparing predicted bits generated using the known LFSR sequence with corresponding received bits. Optionally, the process of locking the descrambler may involve multiple coordinated stages to ensure reliable synchronization. In the self-synchronizing mode, the descrambler uses feedback from received bits to automatically converge to the correct LFSR state, which is more reliable at the lower first throughput due to reduced channel impairments. Once synchronization is achieved, the transition to synchronized mode allows the descrambler to maintain synchronization through its local LFSR rather than depending on the received bits. The verification process compares the locally generated LFSR sequence with received bits to confirm proper synchronization before proceeding with rate increase.

In certain aspects of the system, training the equalizers and cancellers at the second rate may include directly computing errors between received symbols and the known reference sequence while concurrently updating equalizer and canceller parameters, thereby enabling faster convergence than training that requires estimating both the transmitted sequence and the parameters simultaneously. The training speed improvement may be achieved through multiple mechanisms. Without knowledge of the LFSR sequence, training algorithms may need to estimate the transmitted sequence while simultaneously adjusting equalizer and canceller parameters, which can lead to slower convergence due to uncertainty in the reference signal. In contrast, when the LFSR sequence is known, the training algorithms can directly compute the error between received symbols and the known reference sequence, enabling faster parameter updates. Additionally, the known sequence may allow pre-computation of certain correlations and optimization of step sizes, which can further accelerate convergence.

Optionally, the second throughput may be at least 4 times, 16 times, 32 times, 64 times, or 128 times greater than the first throughput, and wherein the first throughput is achieved at a first symbol rate and the second throughput is achieved at a second symbol rate, with the second symbol rate being at least 4 times, 16 times, 32 times, 64 times, or 128 times greater than the first symbol rate. Optionally, the throughput and corresponding symbol rate ratios may be selected to balance the need for reliable initial synchronization at lower rates with the desire for high-speed operation. For example, the symbol rate increase impacts how fast the equalizers and cancellers operate, while the throughput increase determines the overall data transfer capability. When modulation remains constant, these ratios are typically equal. The first symbol rate is chosen to be slow enough to allow reliable self-synchronization and initial training, while the second symbol rate achieves desired operating speeds.

In some embodiments of the system, at the first throughput the transmitter may send the symbols over a single lane, and at the second throughput the transmitter may send the symbols over multiple lanes while maintaining the known LFSR sequence, and wherein the receiver may use the known LFSR sequence to train inter-lane crosstalk cancellers. The transition from single-lane to multi-lane operation may leverage the maintained known LFSR sequence to address additional challenges introduced by multi-lane operation. The known sequence allows the receiver to predict the data on each lane, enabling faster training of inter-lane crosstalk cancellers, which is valuable because crosstalk patterns between lanes can be complex and data dependent. The ability to predict the transmitted patterns on all lanes simultaneously allows the receiver to isolate and characterize crosstalk effects more efficiently than would be possible with unknown data patterns.

In certain aspects, the receiver may be configured to signal readiness to the transmitter before the increase in rate, wherein the readiness signal indicates that a predetermined level of performance has been achieved with the equalizers and cancellers at the first rate. Optionally, a coordination mechanism ensures that rate increase occurs after the receiver has achieved sufficient performance at the first rate to maintain reliable operation after the transition. The readiness signal may be based on multiple performance metrics, which may include mean square error levels, bit error rates, or convergence measures of the equalizers and cancellers. This coordination can prevent premature rate increases that could lead to loss of synchronization or training failure. The predetermined performance level can be selected to provide high confidence that the receiver can maintain synchronization and successfully train at the higher rate.

Optionally, after the increase in rate, the symbols sent from the transmitter may be produced by the same scrambler for which the descrambler was locked while receiving the symbols at the first throughput. Optionally, the system maintains consistency by using the same scrambler before and after the rate transition. This can ensure that the locked state of the descrambler remains valid after the transition, which may simplify the receiver's operation at the higher throughput, and may allow for rate transitions without requiring re-synchronization procedures.

In some embodiments, at the second throughput the transmitter may be configured to distribute bits produced by the scrambler across multiple lanes while maintaining the known LFSR sequence, and wherein the receiver may include a single descrambler for decoding the symbols received on all of the multiple lanes. Optionally, at the second throughput, the bits produced by the scrambler may be distributed across multiple lanes, while maintaining the known LFSR sequence. A single descrambler may be utilized at the receiver to decode the symbols received on all of the multiple lanes. Because all lanes' symbols can originate from the same scrambler and the LFSR sequence is maintained, the single descrambler may be sufficient to handle the decoding for all lanes, which can simplify the receiver design. The distribution of bits across multiple lanes may be achieved through various mechanisms, such as round-robin assignment, interleaved distribution, or other suitable methods that maintain the scrambled sequence properties across all lanes.

Additionally, during transmission at the second throughput, the scrambler may produce at least sixteen bits that are distributed across four lanes in each symbol period, with each lane carrying a Pulse Amplitude Modulation with 16 levels (PAM16) symbol representing four of the at least sixteen bits. The system may implement various schemes for distributing scrambler output bits across multiple lanes. For example, when using four lanes and PAM16 modulation, the scrambler may produce at least sixteen bits per symbol period, which may then be distributed across the four lanes, with each lane carrying a PAM16 symbol that represents four bits. The physical lanes may be implemented using various types of transmission media, such as pairs of wires compliant with different cabling specifications, optical channels, or other suitable transmission paths.

In certain aspects, at the second throughput, the scrambler may produce a number of bits per symbol period that is equal to a number of the multiple lanes multiplied by a number of bits represented by each symbol of a Pulse Amplitude Modulation with 16 levels (PAM16). The system may coordinate the scrambler's bit production rate with the number of lanes and the modulation scheme being used. For example, if there are ‘N’ lanes and the modulation scheme encodes ‘M’ bits per symbol (such as M=4 for PAM16), the scrambler may produce N*M bits per symbol period. This coordination can ensure efficient utilization of the available lanes and maintain proper synchronization between the scrambler and descrambler operations. The specific values of N and M may be selected based on various factors such as the desired throughput, physical channel characteristics, or system requirements.

Optionally, at the first throughput each symbol may represent one bit produced by the scrambler using Pulse Amplitude Modulation with 2 levels (PAM2) modulation at a first symbol rate, and at the second throughput each symbol may represent multiple bits produced by the scrambler using PAM16 modulation at a second symbol rate, and wherein the first symbol rate is at least 4 times, 16 times, 32 times, 64 times, or 128 times slower than the second symbol rate. The relationship between symbols and bits varies between different throughput levels, with corresponding changes in symbol rate. At the first throughput, each transmitted symbol at the first symbol rate represents one bit using PAM2 modulation. At the second throughput, each symbol at the second symbol rate represents multiple bits using PAM16 modulation. The substantial symbol rate increase, combined with the higher bits-per-symbol of PAM16, enables throughput improvement. The system may maintain the known LFSR sequence throughout this transition, enabling efficient training at the higher symbol rate despite the increased complexity of the modulation scheme.

In some embodiments, the receiver may include a non-linear filter, and wherein the receiver may be further configured to train the non-linear filter based on symbols received at the second throughput while utilizing the locked descrambler for decoding the symbols during the training of the non-linear filter. Optionally, the receiver may utilize a non-linear filter to process the received signals. This non-linear filter may be implemented, for example, as a neural network. Unlike linear filters, which may often be trained adequately using simpler modulation schemes, non-linear filters such as neural networks may typically require training data that reflects the characteristics of the actual operating modulation scheme. The system may leverage the locked descrambler to enable direct training of the non-linear filter at the second throughput, which may eliminate the need for intermediate training phases. For example, in the case of a neural network, the decoded symbols may be used along with a suitable training algorithm to adjust the network's weights and biases, allowing the non-linear filter to learn the mapping between the received symbols and the transmitted data.

Additionally, training the non-linear filter may include providing symbols decoded using the locked descrambler as input to the non-linear filter, comparing an output of the non-linear filter to a known sequence to generate an error signal, and adjusting parameters of the non-linear filter based on the error signal. The training process for the non-linear filter, such as a neural network, may involve comparing the filter's output to the known sequence expected based on the scrambler's operation. The known sequence may be derived from the known LFSR sequence established in the locked descrambler. The comparison may generate an error signal that quantifies the difference between the actual and desired outputs, and the error signal may be used to adjust the filter's parameters. In the case of a neural network, this adjustment may be performed using optimization algorithms that iteratively modify the network's weights and biases to minimize the error signal. The use of the known LFSR sequence may provide a reliable reference for training, even at the second throughput where modulation complexity may be higher.

In certain aspects, the receiver may be configured to train the non-linear filter using symbols received at the second throughput without first training the non-linear filter using symbols received at the first throughput. Optionally, the system may leverage the locked descrambler to train the non-linear filter directly at the second throughput, which may eliminate the need for a separate training phase at the first throughput that is typically required before training with more complex modulation schemes. By transitioning directly to the second throughput and utilizing the locked descrambler for decoding, the system may enable efficient training of the non-linear filter. The decoded symbols, which may be accurate due to the locked descrambler, can provide the necessary input for the filter's training algorithm. The filter's parameters may be adjusted based on the received symbols and the known LFSR sequence, allowing it to learn the mapping required for effective signal processing.

Optionally, at the first throughput the transmitter may use Binary Phase-Shift Keying (BPSK) modulation and the scrambler may produce one bit per symbol period, and at the second throughput the transmitter may use Quadrature Phase-Shift Keying (QPSK) modulation and the scrambler may produce two bits per symbol period. Optionally, BPSK may be used at the first throughput, where the phase of a carrier signal can be shifted between two values to represent a digital ‘0’ or ‘1’. This may make BPSK relatively simple to implement and robust against noise, as the receiver may need to distinguish between two possible phase states. At the second throughput, QPSK may be used, which can take one of four values, with each phase representing a unique combination of two bits. The use of BPSK at the first throughput may allow for reliable locking of the descrambler. Once the descrambler is locked and synchronized, the system may transition to QPSK, effectively doubling the data rate. The receiver may leverage the known LFSR sequence to decode the QPSK symbols accurately.

Alternatively, at the first throughput the transmitter may use Binary Phase-Shift Keying (BPSK) modulation and the scrambler may produce one bit per symbol period, and at the second throughput the transmitter may use 16 Quadrature Amplitude Modulation (16-QAM) and the scrambler may produce four bits per symbol period. Optionally, at the first throughput, BPSK may be used for its simplicity and robustness. At the second throughput, 16-QAM may be used, which can combine both amplitude and phase modulation to encode four bits per symbol. Each 16-QAM symbol may take one of 16 distinct states, defined by a unique combination of amplitude and phase, which can achieve a higher data rate than BPSK within the same bandwidth. The scrambler may increase its bit production from one bit per symbol period with BPSK to four bits per symbol period with 16-QAM. The locked descrambler may enable decoding of the 16-QAM symbols, effectively achieving a fourfold increase in data rate.

In some embodiments, the transmitter may be configured to apply line coding to the bits produced by the scrambler at the first rate and/or the second rate to generate line-coded bits, and wherein the symbols sent at the first throughput and/or the second throughput may represent at least a portion of the line-coded bits. The symbols transmitted may be representations of the bits produced by the scrambler, but they may not necessarily be the bits themselves. Line coding may be applied to the bits produced by the scrambler at the first and/or second rates to facilitate various aspects of the transmission, such as DC balance, clock recovery, or error detection. For example, 8b/10b encoding may be used, where each group of 8 bits from the scrambler may be mapped to a corresponding 10-bit codeword, to provide sufficient transitions for clock recovery and maintaining DC balance. The symbols sent at the first and/or second throughputs may then represent these line-coded bits rather than the original scrambler bits, and the receiver should perform the corresponding line decoding to recover the original bits before descrambling.

Additionally, the receiver may be further configured to identify line code word boundaries based on validity of decoded line code words, and to use the identified boundaries to aid in synchronizing the descrambler with the scrambler. The receiver may leverage the properties of the line coding scheme to complement the existing synchronization process. Since valid line code words follow specific patterns and rules (such as running disparity in 8b/10b), the receiver may examine received bit sequences to identify valid codewords, which can indicate proper alignment. This line code validation provides structural information about the data stream that operates independently from, yet complementary to, the LFSR-based synchronization mechanism. By confirming that decoded line code words are valid before they enter the descrambler, the system gains an additional layer of verification that can help detect misalignment issues that may otherwise propagate through the descrambling process.

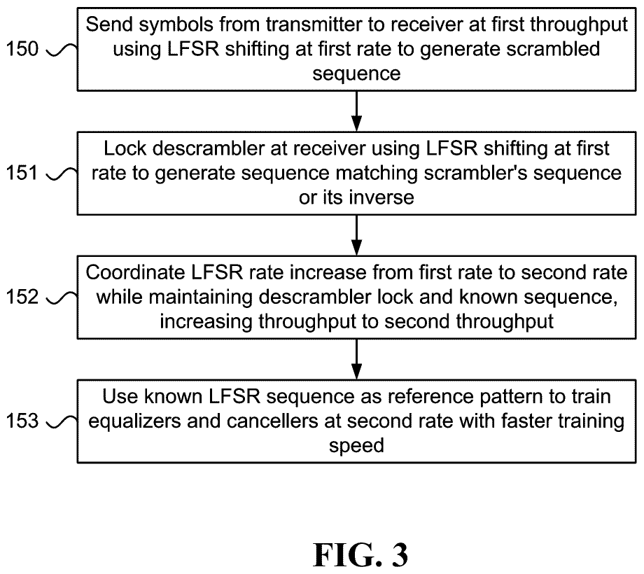

FIG. 3 illustrates one embodiment of a method for communication link training. The method includes the following steps. In step 150, send symbols from transmitter to receiver at first throughput using LFSR shifting at first rate to generate scrambled sequence. In step 151, lock descrambler at receiver using LFSR shifting at first rate to generate sequence matching scrambler's sequence or its inverse. In step 152, coordinate LFSR rate increase from first rate to second rate while maintaining descrambler lock and known sequence, increasing throughput to second throughput. And in step 153, use known LFSR sequence as reference pattern to train equalizers and cancellers at second rate with faster training speed.

In one embodiment, a method includes sending symbols from a transmitter to a receiver at a first throughput, wherein the transmitter comprises a scrambler that utilizes a linear feedback shift register (LFSR) shifting at a first rate, wherein the LFSR generates an LFSR sequence, locking a descrambler at the receiver, wherein the descrambler utilizes an LFSR shifting at the first rate to generate a known LFSR sequence matching the LFSR sequence or its inverse, coordinating an increase in the rate of shifting of the respective LFSRs at the transmitter and the receiver from the first rate to a second rate while maintaining the descrambler locked and maintaining the known LFSR sequence, thereby increasing the throughput of sending symbols from the transmitter to the receiver to a second throughput, and using, at the receiver, the known LFSR sequence as a reference pattern to train equalizers and cancellers at the second rate at a training speed faster than possible without knowing the LFSR sequence.

In some embodiments of the method, locking the descrambler may include operating the descrambler in a self-synchronizing mode to achieve initial synchronization with the scrambler while receiving the symbols at the first throughput, switching the descrambler to operate in a synchronized mode while maintaining synchronization, and verifying successful synchronization by comparing predicted bits generated using the known LFSR sequence with corresponding received bits.

Optionally, training the equalizers and cancellers at the second rate may include computing errors between received symbols and the known reference sequence while concurrently updating equalizer and canceller parameters, thereby enabling faster convergence than training that requires estimating both the transmitted sequence and the parameters simultaneously, and wherein the first throughput corresponds to transmission at a first symbol rate and the second throughput corresponds to transmission at a second symbol rate that is at least 4 times, 16 times, 32 times, 64 times, or 128 times greater than the first symbol rate. The training speed improvement may be achieved through error computation between received symbols and the known reference sequence. The symbol rate increase from the first to second throughput may determine how fast these symbols are processed during training. Without knowledge of the LFSR sequence, training algorithms would need to estimate the transmitted sequence while simultaneously adjusting parameters at the higher symbol rate, leading to slower convergence. The known sequence enables error computation at the increased symbol rate, accelerating parameter updates.

In certain aspects of the method, at the first throughput, the method may include sending the symbols over a single lane, and at the second throughput, sending the symbols over multiple lanes while maintaining the known LFSR sequence, and using, at the receiver, the known LFSR sequence to train inter-lane crosstalk cancellers.

Additionally, the method may include, at the second throughput, distributing bits produced by the scrambler across multiple lanes while maintaining the known LFSR sequence, decoding, at the receiver using a single descrambler, the symbols received on all of the multiple lanes, and during transmission at the second throughput, producing at least sixteen bits by the scrambler that are distributed across four lanes in each symbol period, with each lane carrying a Pulse Amplitude Modulation with 16 levels (PAM16) symbol representing four of the at least sixteen bits.

Optionally, the method may include, at the second throughput, distributing bits produced by the scrambler across multiple lanes while maintaining the known LFSR sequence, decoding, at the receiver using a single descrambler, the symbols received on all of the multiple lanes, and at the second throughput, producing a number of bits per symbol period by the scrambler that is equal to a number of the multiple lanes multiplied by a number of bits represented by each symbol of a Pulse Amplitude Modulation with 16 levels (PAM16).

In some embodiments, the method may further include training a non-linear filter at the receiver based on symbols received at the second throughput while utilizing the locked descrambler for decoding the symbols during the training of the non-linear filter, wherein training the non-linear filter may include providing symbols decoded using the locked descrambler as input to the non-linear filter, comparing an output of the non-linear filter to a known sequence to generate an error signal, and adjusting parameters of the non-linear filter based on the error signal.

The following numbered embodiments are non-limiting embodiments that may be combined with other compatible embodiments described herein and/or may be combined with, or refer to, any compatible claims.
1. In one embodiment, system, comprising: a transmitter configured to send symbols to a receiver at a first throughput, wherein the transmitter comprises a scrambler that utilizes a linear feedback shift register (LFSR) shifting at a first rate, wherein the LFSR generates an LFSR sequence; and a receiver comprising: a descrambler utilizing an LFSR shifting at the first rate, equalizers, and cancellers; wherein the receiver is configured to lock its descrambler to generate a known LFSR sequence matching the LFSR sequence or its inverse; wherein the transmitter and receiver are configured to coordinate an increase in the rate of shifting of their respective LFSRs from the first rate to a second rate while maintaining the descrambler locked and maintaining the known LFSR sequence, thereby increasing the throughput of sending symbols from the transmitter to the receiver to a second throughput; and wherein the receiver is further configured to use the known LFSR sequence as a reference pattern to train the equalizers and cancellers at the second rate at a training speed faster than possible without knowing the LFSR sequence.
2. The system of embodiment 1, wherein the receiver is configured to lock its descrambler by operating the descrambler in a self-synchronizing mode to achieve initial synchronization with the scrambler while receiving the symbols at the first throughput, switching the descrambler to operate in a synchronized mode while maintaining synchronization, and verifying successful synchronization by comparing predicted bits generated using the known LFSR sequence with corresponding received bits.
3. The system of any one of embodiments 1-2, wherein training the equalizers and cancellers at the second rate comprises computing errors between received symbols and the known reference sequence while concurrently updating equalizer and canceller parameters, thereby enabling faster convergence than training that requires estimating both the transmitted sequence and the parameters simultaneously.
4. The system of any one of embodiments 1-3, wherein the second throughput is at least 4 times, 16 times, 32 times, 64 times, or 128 times greater than the first throughput.
5. The system of any one of embodiments 1-4, wherein at the first throughput the transmitter sends the symbols over a single lane, and at the second throughput the transmitter sends the symbols over multiple lanes while maintaining the known LFSR sequence, and wherein the receiver uses the known LFSR sequence to train inter-lane crosstalk cancellers.
6. The system of any one of embodiments 1-5, wherein the receiver is configured to signal readiness to the transmitter before the increase in rate, wherein the readiness signal indicates that a predetermined level of performance has been achieved with the equalizers and cancellers at the first rate.
7. The system of any one of embodiments 1-6, wherein after the increase in rate, the symbols sent from the transmitter are produced by the same scrambler for which the descrambler was locked while receiving the symbols at the first throughput.
8. The system of any one of embodiments 1-7, wherein at the second throughput the transmitter is configured to distribute bits produced by the scrambler across multiple lanes while maintaining the known LFSR sequence, and wherein the receiver comprises a single descrambler for decoding the symbols received on all of the multiple lanes.
9. The system of embodiment 8, wherein at least one of: (i) during transmission at the second throughput, the scrambler produces at least sixteen bits that are distributed across four lanes in each symbol period, with each lane carrying a Pulse Amplitude Modulation with 16 levels (PAM16) symbol representing four of the at least sixteen bits; or (ii) at the second throughput, the scrambler produces a number of bits per symbol period that is equal to a number of the multiple lanes multiplied by a number of bits represented by each symbol of a Pulse Amplitude Modulation with 16 levels (PAM16).
10. The system of any one of embodiments 1-9, wherein at the first throughput each symbol represents one bit produced by the scrambler using Pulse Amplitude Modulation with 2 levels (PAM2) modulation, and at the second throughput each symbol represents multiple bits produced by the scrambler using PAM16 modulation.
11. The system of any one of embodiments 1-10, wherein the receiver comprises a non-linear filter, and wherein the receiver further is configured to train the non-linear filter based on symbols received at the second throughput while utilizing the locked descrambler for decoding the symbols during the training of the non-linear filter.
12. The system of embodiment 11, wherein training the non-linear filter comprises providing symbols decoded using the locked descrambler as input to the non-linear filter, comparing an output of the non-linear filter to a known sequence to generate an error signal, and adjusting parameters of the non-linear filter based on the error signal.
13. The system of any one of embodiments 11-12, wherein the receiver is configured to train the non-linear filter using symbols received at the second throughput without first training the non-linear filter using symbols received at the first throughput.
14. The system of any one of embodiments 1-13, wherein at least one of: (i) at the first throughput the transmitter uses Binary Phase-Shift Keying (BPSK) modulation and the scrambler produces one bit per symbol period, and at the second throughput the transmitter uses Quadrature Phase-Shift Keying (QPSK) modulation and the scrambler produces two bits per symbol period; or (ii) at the first throughput the transmitter uses Binary Phase-Shift Keying (BPSK) modulation and the scrambler produces one bit per symbol period, and at the second throughput the transmitter uses 16 Quadrature Amplitude Modulation (16-QAM) and the scrambler produces four bits per symbol period.
15. The system of any one of embodiments 1-14, wherein the transmitter is configured to apply line coding to the bits produced by the scrambler at the first rate and/or the second rate to generate line-coded bits, and wherein the symbols sent at the first throughput and/or the second throughput represent at least a portion of the line-coded bits.
16. The system of embodiment 15, wherein the receiver is further configured to identify line code word boundaries based on validity of decoded line code words, and to use the identified boundaries to aid in synchronizing the descrambler with the scrambler.
17. In one embodiment, method, comprising: sending symbols from a transmitter to a receiver at a first throughput, wherein the transmitter comprises a scrambler that utilizes a linear feedback shift register (LFSR) shifting at a first rate, wherein the LFSR generates an LFSR sequence; locking a descrambler at the receiver, wherein the descrambler utilizes an LFSR shifting at the first rate to generate a known LFSR sequence matching the LFSR sequence or its inverse; coordinating an increase in the rate of shifting of the respective LFSRs at the transmitter and the receiver from the first rate to a second rate while maintaining the descrambler locked and maintaining the known LFSR sequence, thereby increasing the throughput of sending symbols from the transmitter to the receiver to a second throughput; and using, at the receiver, the known LFSR sequence as a reference pattern to train equalizers and cancellers at the second rate at a training speed faster than possible without knowing the LFSR sequence.
18. The method of embodiment 17, wherein at least one of: (i) locking the descrambler comprises: operating the descrambler in a self-synchronizing mode to achieve initial synchronization with the scrambler while receiving the symbols at the first throughput, switching the descrambler to operate in a synchronized mode while maintaining synchronization, and verifying successful synchronization by comparing predicted bits generated using the known LFSR sequence with corresponding received bits; or (ii) training the equalizers and cancellers at the second rate comprises computing errors between received symbols and the known reference sequence while concurrently updating equalizer and canceller parameters, thereby enabling faster convergence than training that requires estimating both the transmitted sequence and the parameters simultaneously.
19. The method of any one of embodiments 17-18, wherein at the first throughput, sending the symbols over a single lane, and at the second throughput, sending the symbols over multiple lanes while maintaining the known LFSR sequence; and optionally at least one of: (i) using, at the receiver, the known LFSR sequence to train inter-lane crosstalk cancellers; (ii) distributing bits produced by the scrambler across multiple lanes and decoding, at the receiver using a single descrambler, the symbols received on all of the multiple lanes; (iii) during transmission at the second throughput, producing at least sixteen bits by the scrambler that are distributed across four lanes in each symbol period, with each lane carrying a Pulse Amplitude Modulation with 16 levels (PAM16) symbol representing four of the at least sixteen bits; or (iv) at the second throughput, producing a number of bits per symbol period by the scrambler that is equal to a number of the multiple lanes multiplied by a number of bits represented by each symbol of a Pulse Amplitude Modulation with 16 levels (PAM16).
20. The method of any one of embodiments 17-19, further comprising: training a non-linear filter at the receiver based on symbols received at the second throughput while utilizing the locked descrambler for decoding the symbols during the training of the non-linear filter, wherein training the non-linear filter comprises: providing symbols decoded using the locked descrambler as input to the non-linear filter, comparing an output of the non-linear filter to a known sequence to generate an error signal, and adjusting parameters of the non-linear filter based on the error signal.

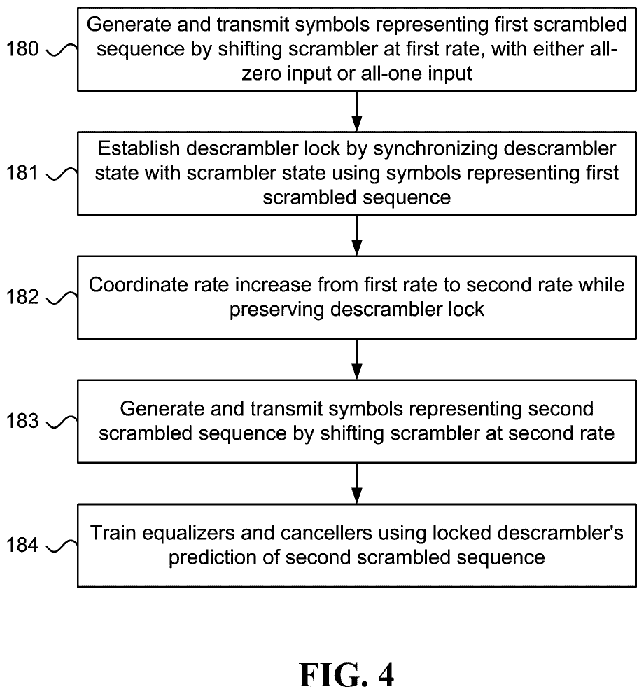

FIG. 4 illustrates one embodiment of a method for communication link training. The method includes the following steps. In step 180, generate and transmit symbols representing first scrambled sequence by shifting scrambler at first rate, with either all-zero input or all-one input. In step 181, establish descrambler lock by synchronizing descrambler state with scrambler state using symbols representing first scrambled sequence. In step 182, coordinate rate increase from first rate to second rate while preserving descrambler lock. In step 183, generate and transmit symbols representing second scrambled sequence by shifting scrambler at second rate. And in step 184, train equalizers and cancellers using locked descrambler's prediction of second scrambled sequence.

In one embodiment, a method for communication link training includes generating and transmitting symbols representing a first scrambled sequence resulting from shifting a scrambler, at a first transceiver, at a first rate, wherein the first scrambled sequence is generated by inputting either all-zero input data or all-one input data to the scrambler, resulting in either a predetermined sequence or its inverse, respectively. The method further includes establishing a descrambler lock, at a second transceiver, based on synchronizing the descrambler's state with the scrambler's state utilizing the symbols representing the first scrambled sequence. Additionally, the method includes coordinating an increase of the first rate to a second rate in a manner that preserves the descrambler lock, generating and transmitting symbols representing a second scrambled sequence resulting from shifting the scrambler at the second rate, and training respective equalizers and cancellers of the second transceiver based on prediction of the second scrambled sequence by the locked descrambler. This method leverages predictable sequences to improve training efficiency. Using all-zero or all-one inputs creates either the pure LFSR sequence or its inverse, providing a known reference pattern that enables faster synchronization compared to arbitrary data. The descrambler lock establishes a shared state between transceivers that, when preserved during rate transition, eliminates the need for re-synchronization at higher rates. It allows equalizers and cancellers to train against a known reference rather than simultaneously attempting to estimate both the transmitted sequence and the channel characteristics, resulting in faster convergence.

In some embodiments of the method, the generating and transmitting symbols may include transmitting the symbols over a single lane both before and after increasing from the first rate to the second rate, wherein transmitting at the first rate corresponds to transmitting symbols at a first symbol rate and transmitting at the second rate corresponds to transmitting symbols at a second symbol rate. In these embodiments, the descrambler lock may be maintained on the single lane during and after the increase from the first rate to the second rate, and the first rate and the first symbol rate may be at least 4 times, 16 times, 32 times, 64 times, or 128 times slower than the second rate and the second symbol rate, respectively. Single lane operation throughout the rate increase simplifies synchronization maintenance by eliminating lane distribution complexities. The scrambler shifting rates correspond to symbol rates at which symbols traverse the channel. The substantial differences in both rates are chosen to balance two competing needs: the first rates are slow enough to enable reliable initial synchronization even under challenging channel conditions, while the second rates are fast enough to achieve desired throughput targets for normal operation. The symbol rate increase affects the speed at which symbols are processed by the receiver's equalizers and cancellers.

Alternatively, in certain aspects of the method, the generating and transmitting symbols representing the first scrambled sequence may include transmitting the symbols over a single lane at the first rate which corresponds to a first symbol rate, and the generating and transmitting symbols representing the second scrambled sequence may include transmitting the symbols over multiple lanes at the second rate which corresponds to a second symbol rate. In these embodiments, the first symbol rate may be at least 4 times, 16 times, 32 times, 64 times, or 128 times slower than the second symbol rate, and the method may further include training inter-lane crosstalk cancellers at the second transceiver based on prediction of the second scrambled sequence while maintaining the descrambler lock. Starting with a single lane at a lower symbol rate simplifies initial synchronization by avoiding inter-lane crosstalk effects. Once synchronization is established at the lower rate, expanding to multiple lanes at a higher symbol rate while maintaining the established lock leverages the known scrambled sequence to identify cross-lane interference patterns. The symbol rate increase affects how rapidly the inter-lane crosstalk cancellers operate to process symbols across multiple lanes.

In some embodiments, establishing the descrambler lock may include inputting a predetermined data pattern to the scrambler, receiving the first scrambled sequence at the second transceiver, and determining the scrambler's state by comparing the received first scrambled sequence with expected scrambled values of the predetermined data pattern. Using a predetermined data pattern enables the receiver to infer the scrambler's state through observation rather than explicit communication, which can be more robust against transmission errors that might corrupt explicit state information. The comparison process essentially creates a template-matching mechanism where the receiver identifies which portion of the expected scrambled sequence is being received, thereby determining the scrambler's current state.

Optionally, coordinating the increase of the first rate to the second rate may include continuing to input the same predetermined data pattern to the scrambler at the second rate. Continuing with the same predetermined pattern during rate increase minimizes variables that could disrupt synchronization. If both the pattern and rate changed simultaneously, the receiver would face a more complex adaptation challenge. By changing the rate while keeping the input pattern constant, it may be easier for the system to preserve the established lock throughout the rate increase.

In certain embodiments, establishing the descrambler lock may include inputting either all-zero input data or all-one input data to the scrambler, receiving the first scrambled sequence at the second transceiver, and determining the scrambler's state by comparing the received first scrambled sequence with expected scrambled values corresponding to either a predetermined sequence or its inverse, respectively. Additionally, coordinating the increase of the first rate to the second rate may include continuing to input the same all-zero input data or all-one input data to the scrambler at the second rate. Maintaining consistent all-zero or all-one inputs during rate increase focuses the change on the rate, which preserves the mathematical relationship between the scrambler and descrambler states across the transition, allowing the receiver to predict how the sequence will appear at the new rate based on its established understanding of the sequence at the previous rate.

In some aspects of the method, establishing the descrambler lock may include transmitting current contents of the scrambler's feedback shift register to the second transceiver, receiving the feedback shift register contents at the second transceiver, and determining the scrambler's state based on the received feedback shift register contents. Direct transmission of register contents provides an explicit synchronization mechanism that can be faster than inference-based approaches. Rather than requiring the receiver to deduce the scrambler state through observation over multiple bits, this method communicates the state information in a single transmission, which may be advantageous in environments with severe time constraints or where channel conditions might make pattern-based synchronization less reliable.

In these embodiments, coordinating the increase of the first rate to the second rate may include transmitting updated register contents after increasing to the second rate. Transmitting updated register contents after the rate increase provides verification that both ends remain properly synchronized despite the timing changes. This state communication serves as a safeguard against potential synchronization errors that could occur during the rate change, especially when the rate increase is substantial. The receiver can compare its predicted state against the received state information to confirm synchronization has been maintained throughout the rate increase.

In certain embodiments of the method, both the first and second scrambled sequences may be generated utilizing the same training pattern as input to the scrambler. Using the same training pattern throughout both rates provides continuity that simplifies transition management. Since the rate is changing while the input pattern remains constant, the receiver can more easily predict how the sequence will evolve after the rate change. This consistency reduces the number of variables changing simultaneously, which can enhance the reliability of maintaining synchronization during the transition.

Alternatively, the first scrambled sequence may be generated utilizing a first training pattern as input to the scrambler, the second scrambled sequence may be generated utilizing a second training pattern as input to the scrambler, and the transition from the first training pattern to the second training pattern may be predefined to occur in coordination with the increase of the first rate to the second rate. Different training patterns optimized for different rates can provide performance advantages if properly coordinated. The first pattern may be selected for superior synchronization properties at lower rates, while the second pattern may offer better training characteristics for equalizers and cancellers at higher rates. The predefined transition point causes both the transmitter and receiver to switch patterns simultaneously, preserving synchronization despite changing both rate and pattern concurrently.

The method may further include training a non-linear filter at the second transceiver based on symbols received at the second rate while utilizing the locked descrambler for decoding the symbols during the training of the non-linear filter. In these embodiments, training the non-linear filter may include providing symbols decoded using the locked descrambler as input to the non-linear filter, comparing an output of the non-linear filter to a known sequence to generate an error signal, and adjusting parameters of the non-linear filter based on the error signal. Non-linear filters, such as neural networks, can model and compensate for channel impairments that linear equalizers cannot address. These filters require accurate training data to properly characterize the non-linear channel effects. The locked descrambler provides the known sequence needed to generate error signals for adjusting the non-linear filter parameters. This error-driven adaptation process enables the filter to learn the mapping between received and expected signals, even with the modulation typically used at faster rates.

In some embodiments, training the non-linear filter may include training the non-linear filter using symbols received at the second rate without first training the non-linear filter using symbols received at the first rate. Training directly at the second rate without intermediate training at the first rate can reduce overall system initialization time, which is made possible by the locked descrambler that provides accurate reference data despite the higher rate's increased complexity.

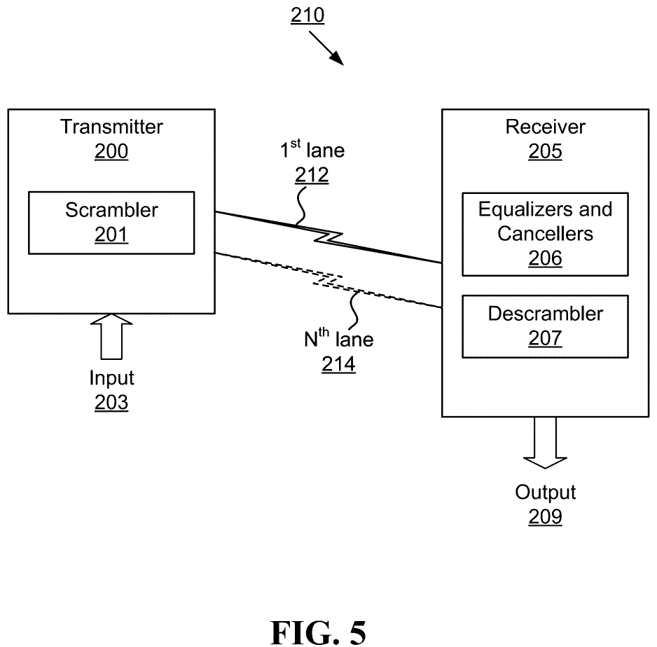

FIG. 5 illustrates one embodiment of a system 210 including a first transceiver and a second transceiver configured to coordinate rate increases while preserving descrambler lock. The first transceiver includes a transmitter 200 that includes a scrambler 201 configured to generate scrambled sequences by shifting at configurable rates. Input 203 provides either all-zero input data or all-one input data to the transmitter 200, resulting in either a predetermined sequence or its inverse, respectively. The transmitter 200 transmits symbols representing the scrambled sequence over multiple communication paths, including 1st lane 212 through Nth lane 214. The second transceiver includes a receiver 205 that includes equalizers and cancellers 206 for signal conditioning, and a descrambler 207 configured to establish descrambler lock based on synchronizing the descrambler's state with the scrambler's state. The receiver 205 is configured to train the respective equalizers and cancellers 206 based on prediction of scrambled sequences by the locked descrambler 207. Output 209 delivers the processed data from the receiver 205. The system coordinates an increase of the scrambler's shifting rate from a first rate to a second rate in a manner that preserves the descrambler lock, enabling the second transceiver to maintain synchronization and continue training the equalizers and cancellers 206 using the locked descrambler 207 to predict the second scrambled sequence.

In one embodiment, a system includes a first transceiver including a scrambler configured to generate a first scrambled sequence by shifting the scrambler at a first rate, wherein the first scrambled sequence is generated by inputting either all-zero input data or all-one input data to the scrambler, resulting in either a predetermined sequence or its inverse, respectively, and transmit symbols representing the first scrambled sequence. The system further includes a second transceiver including a descrambler, equalizers, and cancellers, wherein the second transceiver is configured to establish a descrambler lock based on synchronizing the descrambler's state with the scrambler's state utilizing the symbols representing the first scrambled sequence. The first transceiver and the second transceiver are configured to coordinate an increase of the first rate to a second rate in a manner that preserves the descrambler lock. The first transceiver is further configured to generate and transmit symbols representing a second scrambled sequence resulting from shifting the scrambler at the second rate, and the second transceiver is further configured to train the respective equalizers and cancellers based on prediction of the second scrambled sequence by the locked descrambler.

In some embodiments of the system, the first transceiver may be configured to transmit the symbols over a single lane both before and after increasing from the first rate to the second rate, wherein transmitting at the first rate corresponds to transmitting symbols at a first symbol rate and transmitting at the second rate corresponds to transmitting symbols at a second symbol rate. In these embodiments, the second transceiver may be configured to maintain the descrambler lock on the single lane during and after the increase from the first rate to the second rate, and the first rate and the first symbol rate may be at least 4 times, 16 times, 32 times, 64 times, or 128 times slower than the second rate and the second symbol rate, respectively. The system maintains single lane operation while implementing both LFSR rate and corresponding symbol rate increases. The coordinated increase in both rates ensures that the descrambler lock is preserved while the physical layer adapts to faster symbol transmission. The symbol rate increase determines how quickly the second transceiver's signal processing components operate to maintain synchronization and perform training.

Alternatively, in certain aspects of the system, the first transceiver may be configured to transmit the symbols representing the first scrambled sequence over a single lane at the first rate which corresponds to a first symbol rate and to transmit the symbols representing the second scrambled sequence over multiple lanes at the second rate which corresponds to a second symbol rate. In these embodiments, the first symbol rate may be at least 4 times, 16 times, 32 times, 64 times, or 128 times slower than the second symbol rate, and the second transceiver may be further configured to train inter-lane crosstalk cancellers based on prediction of the second scrambled sequence while maintaining the descrambler lock. The system transitions from single-lane operation at a lower symbol rate to multi-lane operation at a higher symbol rate. The symbol rate increase determines the operating speed for the inter-lane crosstalk cancellers, which process symbols at the higher rate across multiple lanes. The maintained descrambler lock enables accurate prediction of expected symbols on each lane for effective crosstalk canceller training.

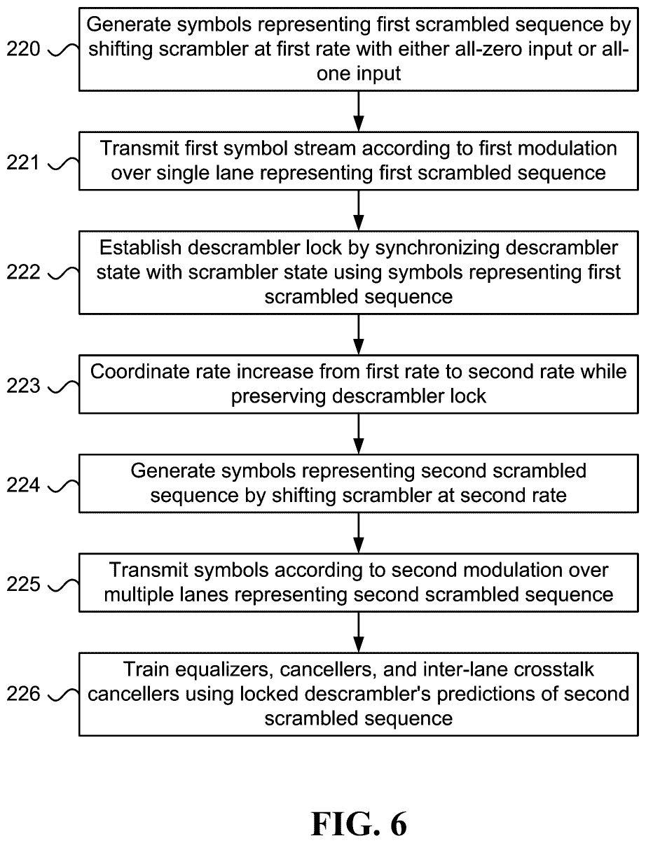

FIG. 6 illustrates one embodiment of a method for multi-lane communication link training. The method includes the following steps. In step 220, generate symbols representing first scrambled sequence by shifting scrambler at first rate with either all-zero input or all-one input. In step 221, transmit first symbol stream according to first modulation over single lane representing first scrambled sequence. In step 222, establish descrambler lock by synchronizing descrambler state with scrambler state using symbols representing first scrambled sequence. In step 223, coordinate rate increase from first rate to second rate while preserving descrambler lock. In step 224, generate symbols representing second scrambled sequence by shifting scrambler at second rate. In step 225, transmit symbols according to second modulation over multiple lanes representing second scrambled sequence. And in step 226, train equalizers, cancellers, and inter-lane crosstalk cancellers using locked descrambler's predictions of second scrambled sequence.

In one embodiment, a method for multi-lane communication link training includes generating symbols representing a first scrambled sequence resulting from shifting a scrambler at a first transceiver at a first rate, wherein the first scrambled sequence is generated by inputting either all-zero input data or all-one input data to the scrambler, resulting in either a predetermined sequence or its inverse, respectively. The method further includes transmitting, according to a first modulation and over a single lane, a first symbol stream representing the first scrambled sequence, establishing a descrambler lock, at a second transceiver, based on synchronizing the descrambler's state with the scrambler's state utilizing the symbols representing the first scrambled sequence, and coordinating an increase of the first rate to a second rate in a manner that preserves the descrambler lock. Additionally, the method includes generating symbols representing a second scrambled sequence resulting from shifting the scrambler at the second rate, transmitting, according to a second modulation and over multiple lanes, the symbols representing the second scrambled sequence, and training respective equalizers, cancellers, and inter-lane crosstalk cancellers of the second transceiver based on predictions of the second scrambled sequence by the locked descrambler. This multi-lane training method builds upon single-lane synchronization by establishing initial communication on one lane before expanding to multiple lanes. Using all-zero or all-one inputs creates the LFSR sequence or its inverse, providing a known reference pattern that enables faster synchronization. The initial single-lane transmission with simpler modulation simplifies the synchronization process by eliminating inter-lane effects during the critical establishment phase. Once the descrambler lock is established and preserved during the rate increase, the system can expand to multiple lanes while leveraging the predictability of the scrambled sequence to train equalizers, cancellers, and inter-lane crosstalk cancellers. The locked descrambler allows the second transceiver to predict the expected sequence across the lanes, providing reference patterns for training that account for both lane-specific impairments and cross-lane interference effects.

The method may further include verifying successful transition to the second modulation by comparing predicted symbols with received symbols across each of the multiple lanes for at least a predetermined number of symbols. Verification of successful transition to the second modulation may involve comparing predicted symbols with actual received symbols across each lane for a predetermined number of symbols. This verification process helps detect synchronization issues that may arise when changing both the modulation scheme and expanding to multiple lanes. The comparison across multiple lanes confirms that the descrambler lock has been properly maintained on each lane and that the modulation change has been correctly implemented. Using a predetermined number of symbols provides sufficient statistical confidence in the verification while balancing the need for thorough testing against time constraints.

The method may further include verifying correct distribution of the scrambled sequence across the multiple lanes by comparing predicted symbol patterns with received symbol patterns on each lane. Verifying correct distribution of the scrambled sequence across multiple lanes may involve comparing predicted symbol patterns with received symbol patterns on each lane. This verification confirms that the distribution algorithm is functioning as expected and that each lane is carrying its intended portion of the scrambled sequence. Incorrect distribution could lead to misinterpretation of the data stream even if individual lanes are functioning properly, thus this verification step helps identify potential issues in how the transmitter allocates bits across lanes or how the receiver reassembles the complete data stream from the multiple lane inputs.

In some embodiments of the method, transmitting over multiple lanes may include progressively activating individual lanes while maintaining the descrambler lock, and verifying successful activation of each lane before activating a subsequent lane. Progressive activation of individual lanes allows for methodical expansion from single lane to multi-lane operation. By activating one lane at a time and verifying successful activation before proceeding to the next lane, the system can isolate and address lane-specific issues without the complexity of debugging multiple lanes simultaneously. This phased activation allows the receiver to adapt to each new lane incrementally while maintaining the descrambler lock throughout the process. The verification between lane activations confirms that each new lane is properly synchronized and functioning before adding the complexity of additional lanes.

In certain aspects of the method, the first modulation may include a first modulation scheme operating at a first symbol rate, the second modulation may include a higher-level modulation scheme operating at a second symbol rate, and the first rate may be at least 4 times, 16 times, 32 times, 64 times, or 128 times slower than the second rate. Additionally, the first symbol rate may be at least 4 times, 16 times, 32 times, 64 times, or 128 times slower than the second symbol rate. The transition from a first modulation scheme to a higher-level modulation scheme corresponds with increases in both the LFSR shifting rate and the symbol rate at which modulated symbols are transmitted. Higher-level modulation schemes encode more bits per symbol, allowing for greater data throughput also when symbol rates do not increase proportionally to data rates. The large differences in both rates provide a balance between establishing reliable synchronization at the lower rates and achieving high throughput at the higher rates. The symbol rate increase affects how fast the inter-lane crosstalk cancellers operate across multiple lanes.

In some embodiments, the coordinating of the increase of the first rate to the second rate may include monitoring channel conditions on each lane, selecting the second modulation based on the monitored channel conditions, and coordinating the transition to the second modulation with both the rate increase and the transition to multiple lanes. Monitoring channel conditions on each lane can provide information for selecting the appropriate second modulation scheme. Different lanes may experience varying levels of noise, attenuation, and/or interference, and the modulation scheme can be adapted accordingly.

The method may further include training a non-linear filter at the second transceiver based on symbols received at the second rate while utilizing the locked descrambler for decoding the symbols during the training of the non-linear filter. In these embodiments, training the non-linear filter may include providing symbols decoded using the locked descrambler as input to the non-linear filter, comparing an output of the non-linear filter to a known sequence to generate an error signal, and adjusting parameters of the non-linear filter based on the error signal. Non-linear filters can model and compensate for channel impairments that linear equalizers cannot address effectively. These filters are capable of handling effects such as signal-dependent noise, phase distortion, and other non-linear channel characteristics. This training process uses the locked descrambler to decode received symbols, which then serve as inputs to the non-linear filter. By comparing the filter's output to the known sequence expected based on the descrambler's predictions, an error signal is generated. This error signal drives parameter adjustments in the non-linear filter, allowing it to learn the mapping between received and expected signals.

In some embodiments, training the non-linear filter may include training the non-linear filter using symbols received at the second rate without first training the non-linear filter using symbols received at the first rate. Training the non-linear filter at the second rate without an intermediate training phase at the first rate may reduce overall system initialization time. This direct training at the higher rate is made possible by the locked descrambler, which provides accurate reference data despite the increased complexity at the higher rate. Traditional filter training often requires gradual adaptation through progressively increasing rates, but the known sequence provided by the locked descrambler may enable reliable error signal generation even at the higher rate, which allows the non-linear filter to converge without requiring the additional intermediate training step.

In one embodiment, a system for multi-lane communication link training includes a first transceiver including a scrambler configured to generate symbols representing a first scrambled sequence by shifting the scrambler at a first rate, wherein the first scrambled sequence is generated by inputting either all-zero input data or all-one input data to the scrambler, resulting in either a predetermined sequence or its inverse, respectively, and transmit, according to a first modulation and over a single lane, a first symbol stream representing the first scrambled sequence. The system further includes a second transceiver including a descrambler, equalizers, cancellers, and inter-lane crosstalk cancellers, wherein the second transceiver is configured to establish a descrambler lock based on synchronizing the descrambler's state with the scrambler's state utilizing the symbols representing the first scrambled sequence. The first transceiver and the second transceiver are configured to coordinate an increase of the first rate to a second rate in a manner that preserves the descrambler lock. The first transceiver is further configured to generate symbols representing a second scrambled sequence resulting from shifting the scrambler at the second rate, and transmit, according to a second modulation and over multiple lanes, the symbols representing the second scrambled sequence. The second transceiver is further configured to train the respective equalizers, cancellers, and inter-lane crosstalk cancellers based on predictions of the second scrambled sequence by the locked descrambler.

In some embodiments of the system, the second transceiver may be further configured to verify successful transition to the second modulation by comparing predicted symbols with received symbols across each of the multiple lanes for at least a predetermined number of symbols.

In certain aspects of the system, the first modulation may include a first modulation scheme operating at a first symbol rate, the second modulation may include a higher-level modulation scheme operating at a second symbol rate, and the first rate may be at least 4 times, 16 times, 32 times, 64 times, or 128 times slower than the second rate. Additionally, the first symbol rate may be at least 4 times, 16 times, 32 times, 64 times, or 128 times slower than the second symbol rate. The system may coordinate modulation changes with both LFSR rate and symbol rate increases to achieve higher throughput. The modulation schemes operate at their respective symbol rates, with the symbol rate increase determining how fast symbols are transmitted across the multiple lanes, which impacts the operating speed requirements for the equalizers, cancellers, and inter-lane crosstalk cancellers. The maintained descrambler lock across these transitions enables effective training at the higher symbol rate despite the increased complexity from both the modulation change and multi-lane operation.

In some embodiments of the system, the second transceiver may further include a non-linear filter, and the second transceiver may be further configured to train the non-linear filter based on symbols received at the second rate while utilizing the locked descrambler for decoding the symbols during the training of the non-linear filter. In these embodiments, training the non-linear filter may include providing symbols decoded using the locked descrambler as input to the non-linear filter, comparing an output of the non-linear filter to a known sequence to generate an error signal, and adjusting parameters of the non-linear filter based on the error signal.

The following numbered embodiments are non-limiting embodiments that may be combined with other compatible embodiments described herein and/or may be combined with, or refer to, any compatible claims.
1. In one embodiment, method for communication link training, comprising: generating and transmitting symbols representing a first scrambled sequence resulting from shifting a scrambler, at a first transceiver, at a first rate, wherein the first scrambled sequence is generated by inputting either all-zero input data or all-one input data to the scrambler, resulting in either a predetermined sequence or its inverse, respectively; establishing a descrambler lock, at a second transceiver, based on synchronizing the descrambler's state with the scrambler's state utilizing the symbols representing the first scrambled sequence; coordinating an increase of the first rate to a second rate in a manner that preserves the descrambler lock; generating and transmitting symbols representing a second scrambled sequence resulting from shifting the scrambler at the second rate; and training respective equalizers and cancellers of the second transceiver based on prediction of the second scrambled sequence by the locked descrambler.
2. The method of embodiment 1, wherein the generating and transmitting symbols comprises transmitting the symbols over a single lane both before and after increasing from the first rate to the second rate; wherein the descrambler lock is maintained on the single lane during and after the increase from the first rate to the second rate; and wherein the first rate is at least 4 times, 16 times, 32 times, 64 times, or 128 times slower than the second rate.
3. The method of embodiment 1, wherein the generating and transmitting symbols representing the first scrambled sequence comprises transmitting the symbols over a single lane at the first rate, and wherein the generating and transmitting symbols representing the second scrambled sequence comprises transmitting the symbols over multiple lanes at the second rate; and further comprising training inter-lane crosstalk cancellers at the second transceiver based on prediction of the second scrambled sequence while maintaining the descrambler lock.
4. The method of any one of embodiments 1-3, wherein establishing the descrambler lock comprises: inputting a predetermined data pattern to the scrambler, receiving the first scrambled sequence at the second transceiver, and determining the scrambler's state by comparing the received first scrambled sequence with expected scrambled values of the predetermined data pattern; and wherein coordinating the increase of the first rate to the second rate comprises continuing to input the same predetermined data pattern to the scrambler at the second rate.
5. The method of any one of embodiments 1-3, wherein establishing the descrambler lock comprises: inputting either all-zero input data or all-one input data to the scrambler, receiving the first scrambled sequence at the second transceiver, and determining the scrambler's state by comparing the received first scrambled sequence with expected scrambled values corresponding to either a predetermined sequence or its inverse, respectively; and wherein coordinating the increase of the first rate to the second rate comprises continuing to input the same all-zero input data or all-one input data to the scrambler at the second rate.
6. The method of any one of embodiments 1-5, wherein establishing the descrambler lock comprises: transmitting current contents of the scrambler's feedback shift register to the second transceiver, receiving the feedback shift register contents at the second transceiver, and determining the scrambler's state based on the received feedback shift register contents; and wherein coordinating the increase of the first rate to the second rate comprises transmitting updated register contents after increasing to the second rate.
7. The method of any one of embodiments 1-6, wherein both the first and second scrambled sequences are generated utilizing the same training pattern as input to the scrambler, or wherein the first scrambled sequence is generated utilizing a first training pattern as input to the scrambler, the second scrambled sequence is generated utilizing a second training pattern as input to the scrambler, and wherein the transition from the first training pattern to the second training pattern is predefined to occur in coordination with the increase of the first rate to the second rate.
8. The method of any one of embodiments 1-7, further comprising: training a non-linear filter at the second transceiver based on symbols received at the second rate while utilizing the locked descrambler for decoding the symbols during the training of the non-linear filter, wherein training the non-linear filter comprises: providing symbols decoded using the locked descrambler as input to the non-linear filter, comparing an output of the non-linear filter to a known sequence to generate an error signal, and adjusting parameters of the non-linear filter based on the error signal.
9. The method of embodiment 8, wherein training the non-linear filter comprises training the non-linear filter using symbols received at the second rate without first training the non-linear filter using symbols received at the first rate.
10. The method of embodiment 1, further comprising: transmitting, according to a first modulation and over a single lane, a first symbol stream representing the first scrambled sequence; transmitting, according to a second modulation and over multiple lanes, the symbols representing the second scrambled sequence; and training inter-lane crosstalk cancellers of the second transceiver based on predictions of the second scrambled sequence by the locked descrambler.
11. The method of embodiment 10, further comprising verifying correct distribution of the scrambled sequence across the multiple lanes by comparing predicted symbol patterns with received symbol patterns on each lane.
12. The method of embodiment 10, wherein transmitting over multiple lanes comprises progressively activating individual lanes while maintaining the descrambler lock, and verifying successful activation of each lane before activating a subsequent lane.
13. In one embodiment, system, comprising: a first transceiver comprising a scrambler configured to: generate a first scrambled sequence by shifting the scrambler at a first rate, wherein the first scrambled sequence is generated by inputting either all-zero input data or all-one input data to the scrambler, resulting in either a predetermined sequence or its inverse, respectively, and transmit symbols representing the first scrambled sequence; a second transceiver comprising a descrambler, equalizers, and cancellers, wherein the second transceiver is configured to establish a descrambler lock based on synchronizing the descrambler's state with the scrambler's state utilizing the symbols representing the first scrambled sequence; wherein the first transceiver and the second transceiver are configured to coordinate an increase of the first rate to a second rate in a manner that preserves the descrambler lock; wherein the first transceiver is further configured to generate and transmit symbols representing a second scrambled sequence resulting from shifting the scrambler at the second rate; and wherein the second transceiver is further configured to train the respective equalizers and cancellers based on prediction of the second scrambled sequence by the locked descrambler.
14. The system of embodiment 13, wherein the first transceiver is configured to transmit the symbols over a single lane both before and after increasing from the first rate to the second rate; wherein the second transceiver is configured to maintain the descrambler lock on the single lane during and after the increase from the first rate to the second rate; and wherein the first rate is at least 4 times, 16 times, 32 times, 64 times, or 128 times slower than the second rate.
15. The system of embodiment 13, wherein the first transceiver is configured to transmit the symbols representing the first scrambled sequence over a single lane at the first rate and to transmit the symbols representing the second scrambled sequence over multiple lanes at the second rate; and wherein the second transceiver is further configured to train inter-lane crosstalk cancellers based on prediction of the second scrambled sequence while maintaining the descrambler lock.
16. The system of embodiment 13, wherein the first transceiver is further configured to: transmit, according to a first modulation and over a single lane, a first symbol stream representing the first scrambled sequence; and transmit, according to a second modulation and over multiple lanes, the symbols representing the second scrambled sequence; and wherein the second transceiver further comprises inter-lane crosstalk cancellers and is further configured to train the respective equalizers, cancellers, and inter-lane crosstalk cancellers based on predictions of the second scrambled sequence by the locked descrambler.
17. The system of any one of embodiments 13-16, wherein the second transceiver further comprises a non-linear filter; and the second transceiver is further configured to train the non-linear filter based on symbols received at the second rate while utilizing the locked descrambler for decoding the symbols during the training of the non-linear filter, wherein training the non-linear filter comprises: providing symbols decoded using the locked descrambler as input to the non-linear filter, comparing an output of the non-linear filter to a known sequence to generate an error signal, and adjusting parameters of the non-linear filter based on the error signal.

In one embodiment, a communication system implements a process for establishing and maintaining synchronization using a constant-rate scrambler while adaptively increasing data throughput. It may utilize a scrambler operating at a consistent high rotation rate throughout the communication process, while selectively transmitting a subset of the generated bits during initial synchronization phases. The system may begin by transmitting a limited subset of scrambled bits, which may allow the receiver to establish synchronization with the transmitter's scrambler sequence through reconstructing the scrambler state based on the limited transmission. After achieving synchronization, the system may increase the data throughput by transmitting a larger subset of the scrambled bits or all of the scrambled bits, and/or by distributing the bits across multiple communication lanes.

The synchronization process may include verification steps where the receiver compares predicted bits with received bits to confirm proper synchronization. The system may maintain the scrambler's rotation rate constant throughout these transitions, which may simplify the synchronization maintenance process, and may provide flexibility in adapting the communication throughput without having to modify the fundamental scrambler timing parameters.

In one embodiment, a system includes a transmitter including a scrambler that utilizes a linear feedback shift register (LFSR) that shifts at a constant rate, wherein the transmitter is configured to selectively transmit a first subset of bits from the scrambler during an initial synchronization phase. The system further includes a receiver configured to receive the first subset of bits, reconstruct a state of the LFSR in the scrambler based on the first subset of bits, and establish synchronization between a descrambler at the receiver and the scrambler based on the reconstructed state. The transmitter is further configured to increase data throughput by transmitting a second subset of bits from the scrambler while maintaining the constant rate, wherein the second subset includes more bits than the first subset, and the receiver is further configured to process the increased data throughput while maintaining synchronization between the descrambler and the scrambler. In this system, the scrambler's LFSR maintains a constant shift rate throughout the communication process. During initial synchronization, a subset of the bits generated by the scrambler may be transmitted, which can allow the receiver to establish synchronization while transmitting at an effectively lower data rate. The selective transmission of bits may be implemented through various mechanisms, such as periodic selection (e.g., every Nth bit), position-based selection, or other appropriate selection methods. Once synchronization is established, the system may increase data throughput by transmitting a larger subset of the scrambled bits or potentially all bits, while maintaining the same constant shift rate of the LFSR. This embodiment may provide benefits in terms of simplified timing control and synchronization maintenance during throughput transitions.

In some embodiments of the system, the receiver may be further configured to verify successful synchronization by comparing a sequence of predicted bits generated by the descrambler with corresponding received bits from the first subset of bits transmitted by the transmitter. The verification process may involve comparing a sequence of bits predicted by the descrambler, based on its reconstructed LFSR state, with the corresponding bits received from the transmitter. This comparison may provide confirmation that the receiver has correctly reconstructed the scrambler's LFSR state and established proper synchronization. The number of bits compared may be selected to provide sufficient confidence in the synchronization verification while balancing efficiency considerations.

In certain aspects of the system, the first subset of bits may be selected according to at least one of: periodic selection of every Nth bit generated by the scrambler, position-based selection of bits at predetermined positions in the scrambler output sequence, or pattern-based selection where bits are selected according to a predetermined pattern. The system may employ various methods for selecting which bits from the scrambler output sequence to transmit during the initial synchronization phase. These methods may include periodic selection, where every Nth bit generated by the scrambler is transmitted (with N being any suitable integer value); position-based selection, where bits at specific predetermined positions in the output sequence are transmitted; or pattern-based selection, where bits are selected according to a predefined pattern that may optimize synchronization efficiency. The specific selection method may be chosen based on factors such as channel characteristics, desired synchronization speed, or system constraints.

In some embodiments, the receiver may further include equalizers and cancellers, and the receiver may be further configured to train the equalizers and cancellers utilizing the synchronization between the descrambler and the scrambler to predict incoming transmitter symbols. Once synchronization is established, the receiver may leverage it to train its signal processing components. The synchronized descrambler may generate predicted symbols that match those transmitted, providing a reference pattern for training equalizers and cancellers. This training process may optimize the receiver's ability to recover transmitted symbols under various channel conditions. The training may occur during both the initial synchronization phase and the subsequent increased throughput phase, with potential refinements during the transition between phases.

In certain embodiments, training the equalizers and cancellers may include using a sequence generated by the LFSR in the descrambler or its inverse as a reference pattern for direct error computation and parameter adaptation, thereby achieving faster convergence than training that requires estimating both the transmitted sequence and the parameters simultaneously. The training process may leverage the knowledge of the LFSR sequence to implement more efficient training algorithms. When the receiver knows the transmitted sequence (through its synchronized descrambler), it can compute the error between received symbols and the expected reference pattern, rather than having to estimate both the transmitted sequence and adaptation parameters simultaneously. This embodiment may allow for faster convergence of the equalizer and canceller parameters, as the uncertainty in the reference signal is eliminated. The training algorithms may include adaptive processes that adjust filter coefficients based on minimizing the computed error, with potential optimizations in step sizes and convergence strategies based on the known sequence characteristics.

In some aspects of the system, the transmitter may be configured to transmit the first subset of bits over a single lane during the initial synchronization phase, and increasing the data throughput may include the transmitter distributing bits from the scrambler across multiple lanes, and the receiver may be configured to maintain the established synchronization across the multiple lanes. The system may transition from single-lane to multi-lane operation as part of increasing the data throughput. In this configuration, the bits generated by the scrambler operating at the constant rate may be distributed across multiple lanes according to a predetermined distribution scheme known to both the transmitter and receiver. The receiver may maintain the established synchronization across all lanes, as the fundamental timing relationship between the scrambler and descrambler remains unchanged despite the expanded distribution of bits across multiple lanes.

In these embodiments, the receiver may be further configured to verify successful synchronization across the multiple lanes by predicting expected received bits for each lane based on the established synchronization and comparing the predicted bits with received bits on each respective lane. When operating across multiple lanes, the receiver may verify that synchronization is properly maintained by comparing predicted bits with received bits on each individual lane. This verification process may confirm that the distribution of bits across lanes is correctly implemented and that synchronization is preserved across all lanes. The prediction of expected bits may be derived from the receiver's synchronized descrambler state combined with knowledge of how the transmitter distributes bits across the multiple lanes.

In certain embodiments, the receiver may further include inter-lane crosstalk cancellers, and the receiver may be further configured to train the inter-lane crosstalk cancellers by isolating crosstalk interference patterns between lanes using predicted data sequence for each lane, calculating a crosstalk transfer function between adjacent lanes, adaptively updating crosstalk cancellation coefficients based on the crosstalk transfer function, and verifying cancellation performance using a sequence generated by the LFSR in the descrambler as a reference. In multi-lane operations, the receiver may implement sophisticated techniques to address inter-lane crosstalk. The synchronized descrambler provides knowledge of the expected data on each lane, allowing the receiver to isolate the crosstalk effects between lanes. The receiver may calculate crosstalk transfer functions that characterize how signals from one lane affect the others, which may include both linear and non-linear components. Using these transfer functions, the receiver may develop and adaptively update cancellation coefficients that counteract the identified crosstalk patterns. The known LFSR sequence may serve as a reference pattern to evaluate the effectiveness of the crosstalk cancellation, enabling the receiver to refine its cancellation techniques to optimize performance across all lanes under varying operating conditions.

In some embodiments, upon failing to verify successful synchronization, the receiver may be configured to signal the synchronization failure to the transmitter, reset its descrambler to an initialization state, and restart the synchronization process with adjusted equalization and timing recovery parameters, wherein the transmitter may be configured to respond to the synchronization failure signal by resetting its scrambler to a predetermined state. The system may implement a coordinated recovery procedure to address scenarios where synchronization verification fails. When synchronization failure is detected, the receiver may signal this condition to the transmitter and reset its descrambler to a known initialization state. The transmitter may respond by resetting its scrambler to a predetermined state, which may re-establish a known starting point for the synchronization process. The reset and restart process may incorporate adjustments to receiver parameters, such as equalization settings, timing recovery algorithms, or bit sampling thresholds, which may improve the probability of successful synchronization in the subsequent attempt.

In certain aspects of the system, the receiver may be configured to calculate and monitor multiple synchronization quality metrics including at least: a bit prediction accuracy rate, a phase alignment stability measure, and an LFSR state confidence score, and decisions to proceed with throughput increases may be based on these metrics meeting predetermined thresholds. The receiver may implement synchronization quality monitoring by calculating and tracking multiple metrics that characterize different aspects of the synchronization status. The bit prediction accuracy rate may quantify how well the receiver's predicted bits match the received bits, providing a direct measure of synchronization accuracy. The phase alignment stability measure may evaluate the consistency of timing relationships between the transmitter and receiver. The LFSR state confidence score may quantify the receiver's statistical confidence in its reconstruction of the transmitter's LFSR state. By monitoring these metrics against predetermined thresholds, the system may make data-driven decisions about when to proceed with throughput increases, which may optimize reliability while minimizing unnecessary delays in the transition process.

In some embodiments, the receiver may further include a non-linear filter including at least one of: a decision feedback equalizer with adaptively trained feedback coefficients, a non-linear filter with dynamically adjusted kernel coefficients, or a neural network with multiple layers, and the receiver may be further configured to train the non-linear filter based on providing received symbols as inputs to the non-linear filter, comparing outputs of the non-linear filter with expected symbols derived from a sequence generated by the LFSR in the descrambler to generate error signals, and adjusting parameters of the non-linear filter using a gradient-based optimization algorithm to minimize the error signals. The system may implement various types of non-linear filters to address channel impairments that cannot be adequately compensated by linear processing alone. A decision feedback equalizer may use previously detected symbols to cancel inter-symbol interference, with adaptively trained feedback coefficients that adjust to channel conditions. A non-linear filter may model and compensate for non-linear distortions using higher-order kernels with dynamically adjusted coefficients. A neural network implementation may leverage multiple processing layers to learn and compensate for complex channel characteristics. Regardless of the specific implementation, the training process may leverage the known LFSR sequence as a reference for generating error signals that guide parameter optimization. The received symbols may be processed through the non-linear filter, and the outputs compared with the expected symbols based on the known LFSR sequence. The resulting error signals may drive a gradient-based optimization algorithm, such as stochastic gradient descent or more advanced variants, which adjusts the filter parameters to minimize the error. This optimization process may be efficient in this system due to the availability of the known reference sequence throughout both the initial synchronization and increased throughput phases.

In certain embodiments of the system, the scrambler may receive either all-zero input data or all-one input data during the initial synchronization phase, resulting in the first subset of bits corresponding to either a predetermined LFSR sequence or its inverse, respectively, and the receiver may reconstruct the state of the LFSR by comparing the received first subset of bits with expected values of the predetermined LFSR sequence or its inverse.

In these embodiments, the transmitter may continue to input the same all-zero input data or all-one input data to the scrambler when transmitting the second subset of bits. During the initial synchronization phase, the transmitter may apply either all-zero input data or all-one input data to the scrambler. When all-zero input data is applied, the scrambler's output reflects the LFSR sequence itself, as the input data does not modify the sequence. Conversely, when all-one input data is applied, the scrambler's output produces the inverse of the LFSR sequence, as each bit from the LFSR is inverted by the XOR operation with the input bit value of ‘1’. Both scenarios result in predictable, deterministic patterns that facilitate reconstruction of the LFSR state at the receiver. The receiver can compare the received bits against expected values of either the predetermined LFSR sequence or its inverse to determine the state of the transmitter's LFSR. After successfully establishing synchronization and transitioning to higher throughput, the transmitter may continue to apply the same all-zero or all-one input data to maintain consistency in the transmitted bit patterns. This consistency allows the receiver to maintain synchronization while processing the increased data volume, as the underlying LFSR sequence remains predictable despite the higher throughput.

In some aspects of the system, the reconstructed state may be a future state of the LFSR, and the receiver may reconstruct the state by applying a pre-computed binary prediction matrix to an observation vector including the first subset of bits, wherein the binary prediction matrix may be computed offline based on a generator polynomial of the LFSR and a pattern of the first subset of bits. The receiver may implement a deterministic mathematical approach for reconstructing the LFSR state, where the reconstructed state corresponds to a future state that the LFSR will reach at a predetermined time. This reconstruction may be achieved using a pre-computed binary prediction matrix that is calculated offline based on the known LFSR generator polynomial and the specific pattern used for selecting the first subset of bits (e.g., every Nth bit). When the receiver collects the sparse observation bits into an observation vector, it may perform a binary matrix multiplication with the prediction matrix to compute what the LFSR state will be at a specific future point.

In these embodiments, the future state may correspond to an LFSR state at a predetermined number of LFSR steps after a last bit of the first subset of bits is received, and the predetermined number of LFSR steps may account for computation time required to perform the binary matrix multiplication. The prediction matrix may be designed to reconstruct an LFSR state that will occur at a specific future point in time. This future point may be determined by: the time when the last observation bit is received, plus a predetermined number of additional LFSR steps accounting for the computation time needed to perform the binary matrix multiplication. This timing coordination may ensure that when the receiver completes its computation and loads the reconstructed state into its descrambler, the reconstructed state matches the transmitter's LFSR state at that moment, enabling synchronization without requiring additional state advancement calculations.

In certain embodiments, for an n-bit LFSR, the binary prediction matrix may include n on n binary values, and the first subset of bits may include at least n observation bits with known spacing between consecutive observation bits. The dimensions of the prediction matrix may correspond to the size of the LFSR. For an n-bit LFSR, the prediction matrix may be an n on n (n×n) binary matrix, and the receiver may need to collect at least n observation bits to determine the future LFSR state. The spacing between consecutive observation bits may be known and consistent (e.g., every Nth bit from the scrambler output), which may be incorporated into the computation of the prediction matrix. The binary nature of the matrix and vector operations may enable efficient hardware implementation using XOR gates and relatively simple logic circuits.

In some embodiments, the establishing synchronization based on the reconstructed state may include collecting the first subset of bits into the observation vector, performing binary matrix multiplication of the observation vector with the binary prediction matrix to compute the future state, loading the computed future state into the descrambler at a predetermined time corresponding to when the LFSR in the scrambler reaches the computed future state, and initiating descrambler operation synchronized with the scrambler. In one embodiment, the synchronization establishment process may follow a deterministic sequence of operations. First, the receiver may collect all necessary observation bits from the first subset into an observation vector. Next, it may perform the binary matrix multiplication to compute the future LFSR state. The receiver may then wait until a predetermined moment (which may be calculated based on when the last observation bit was received plus the computation time) to load the computed state into its descrambler. At this moment, the transmitter's LFSR will have advanced to the reconstructed future state, enabling the receiver's descrambler to begin operation in synchronization with the transmitter's scrambler, which may provide reliable and predictable synchronization timing.

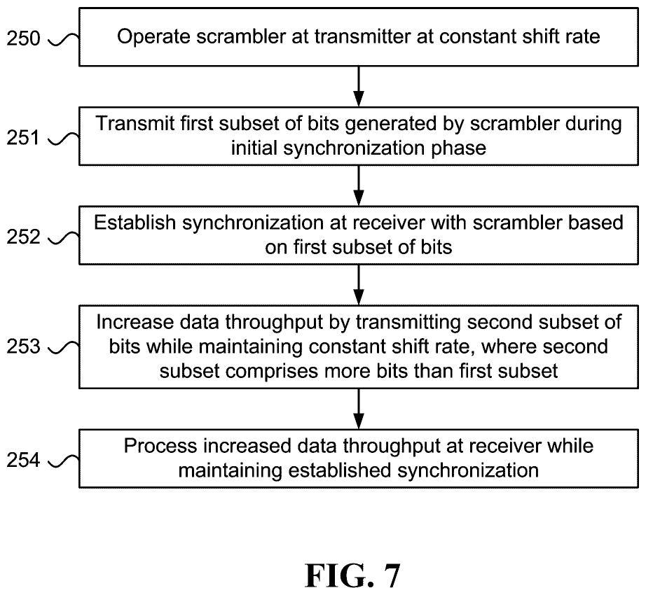

FIG. 7 illustrates one embodiment of a method for selective bit transmission with constant-rate scrambler. The method includes the following steps. In step 250, operate scrambler at transmitter at constant shift rate. In step 251, transmit first subset of bits generated by scrambler during initial synchronization phase. In step 252, establish synchronization at receiver with scrambler based on first subset of bits. In step 253, increase data throughput by transmitting second subset of bits while maintaining constant shift rate, where second subset includes more bits than first subset. And in step 254, process increased data throughput at receiver while maintaining established synchronization.

In one embodiment, a method includes operating a scrambler at a transmitter at a constant shift rate, transmitting a first subset of bits generated by the scrambler during an initial synchronization phase, establishing, at a receiver, synchronization with the scrambler based on the first subset of bits, increasing data throughput by transmitting a second subset of bits from the scrambler while maintaining the constant shift rate, wherein the second subset includes more bits than the first subset, and processing the increased data throughput at the receiver while maintaining the established synchronization. The method may implement a process for establishing and maintaining synchronization while adapting data throughput without changing the scrambler's fundamental shift rate. By operating the scrambler at a constant rate throughout the process but selectively transmitting different subsets of the generated bits, the system may achieve effective rate adaptation while simplifying synchronization maintenance.

The method may further include maintaining transmission of the second subset of bits for a predetermined stabilization period after increasing the data throughput, monitoring receiver performance metrics during the stabilization period, determining that the receiver has achieved stable operation based on the performance metrics reaching predetermined thresholds, and transitioning to processing arbitrary input data after the stabilization period and determination of stable operation. The method may implement a controlled transition between the training phase and normal operation by incorporating a stabilization period. After increasing to the second subset of bits but before transitioning to arbitrary input data, the system may maintain the predictable scrambler-generated pattern for a predetermined period. During this stabilization period, the receiver may continue to refine its signal processing parameters and monitor various performance metrics such as error rates, equalizer convergence indicators, or signal quality measurements. The transition to arbitrary input data may occur after these metrics reach predetermined threshold values, indicating that the receiver has achieved stable operation under the increased throughput conditions. This measured approach to transitioning between operational phases may enhance overall system reliability by ensuring the receiver is fully adapted to the new conditions before introducing the variability of arbitrary data.

In some embodiments of the method, transmitting the first subset of bits may include using a first modulation scheme, and transmitting the second subset of bits may include using a second modulation scheme that encodes more bits per symbol than the first modulation scheme. The method may incorporate modulation adaptation as part of the throughput increase process. During the initial synchronization phase, a simpler modulation scheme encoding fewer bits per symbol may be used, which may provide greater robustness for establishing synchronization. After synchronization is established, the system may transition to a more complex modulation scheme that encodes more bits per symbol, effectively increasing throughput without necessarily changing the symbol rate. This modulation adaptation may be coordinated with the selective bit transmission approach to optimize overall system performance.

The method may further include verifying successful synchronization by comparing a predetermined number of predicted bits generated by a descrambler at the receiver with corresponding received bits, wherein the predetermined number of bits may be selected based on a length of an LFSR implemented in the scrambler to provide enhanced verification confidence. The verification process may provide confirmation of proper synchronization before proceeding with increased throughput, which may contribute to reliable operation across the transition. The verification process may include comparing a sequence of bits predicted by the receiver's descrambler with the corresponding bits received from the transmitter. Using a number of bits that exceeds the length of the LFSR may provide greater statistical confidence in the verification result, as it confirms proper synchronization across a complete cycle of the LFSR sequence plus additional transitions. The verification may be performed both during the initial synchronization phase and again after transitioning to the higher throughput phase to confirm that synchronization has been maintained through the transition.

The method may further include training a non-linear filter at the receiver during the initial synchronization phase using the first subset of bits as a training reference, continuing to train the non-linear filter during increased data throughput using a synchronized descrambler to predict incoming bits, and dynamically adjusting non-linear filter parameters to compensate for channel non-linearities detected during transition between phases. The method may incorporate training of advanced non-linear signal processing components at the receiver. During the initial synchronization phase, the receiver may begin training the non-linear filter using the limited first subset of bits as a reference pattern. After establishing synchronization and increasing to the second subset of bits, the training may continue with the expanded data set while maintaining the known reference through the synchronized descrambler. This may allow the non-linear filter to first establish baseline parameters under simpler conditions before refining its operation for the higher throughput conditions. The constant scrambler rate throughout these phases may provide timing consistency that simplifies the training process while the non-linear filter adapts to the increased data density.

The method may further include evaluating, at the receiver, a synchronization accuracy level, signaling, from the receiver to the transmitter, a readiness indication when the synchronization accuracy level exceeds a predetermined threshold, and increasing the data throughput by transmitting the second subset of bits after the transmitter receives the readiness indication. The method may implement an explicit coordination mechanism between the receiver and transmitter to ensure that throughput increases occur when appropriate conditions are met. The receiver may evaluate its synchronization status using various metrics to determine when sufficient accuracy has been achieved for reliable operation at the higher throughput. Upon reaching the predetermined accuracy threshold, the receiver may transmit a readiness indication to the transmitter, which serves as an explicit authorization to proceed with the throughput increase. This coordination may prevent premature transitions that could compromise system performance and may provide a reliable framework for managing state transitions across distributed components. The specific criteria for determining readiness may be selected based on system requirements and may be adjusted according to operating conditions.

The method may further include transmitting the first subset of bits over a single lane during the initial synchronization phase, distributing the second subset of bits across multiple lanes during the increased data throughput phase, and maintaining the established synchronization across the multiple lanes by using a single descrambler at the receiver to process bits from all lanes based on knowledge of how bits are distributed. The method may incorporate a transition from single-lane to multi-lane operation as part of the throughput increase process. During the initial synchronization phase, bits may be transmitted over a single lane to simplify the establishment of synchronization. After synchronization is established, the system may distribute bits across multiple lanes to increase overall throughput, while maintaining the constant shift rate of the scrambler. The receiver may use a single descrambler to process the bits from all lanes, leveraging knowledge of the distribution pattern to correctly reconstruct the original scrambler sequence, which may simplify receiver architecture compared to implementations requiring separate descramblers for each lane, while still achieving the throughput benefits of multi-lane operation.

In some embodiments of the method, the establishing of the synchronization may include reconstructing a future state of the scrambler by applying a pre-computed binary prediction matrix to an observation vector including the first subset of bits, wherein the binary prediction matrix may be computed offline based on a generator polynomial of the scrambler and a pattern of the first subset of bits. The method may employ a deterministic mathematical approach for establishing synchronization by reconstructing a future state of the scrambler's LFSR. The reconstruction may utilize a pre-computed binary prediction matrix that is calculated offline based on the known generator polynomial and the pattern used for selecting the first subset of bits. The sparse observation bits received during the initial synchronization phase may be collected into an observation vector, which is then multiplied with the prediction matrix to compute the future state that the scrambler will reach at a predetermined time.

In these embodiments, the future state may correspond to a scrambler state at a predetermined number of shift steps after a last bit of the first subset of bits is received, and the predetermined number of shift steps may account for computation time required to perform the binary matrix multiplication. The method may coordinate the timing of the reconstructed state to account for practical implementation constraints. The prediction matrix may be designed to compute a state that the scrambler will reach after receiving the last observation bit, plus a predetermined number of additional shift steps corresponding to the computation time. This timing design may ensure that when the reconstruction computation completes, the computed state matches the actual scrambler state at that moment, enabling synchronization.

In certain aspects, for an n-bit scrambler, the binary prediction matrix may include n on n binary values, and transmitting the first subset of bits may include transmitting at least n observation bits with known spacing between consecutive observation bits. The method may require specific dimensional relationships between the scrambler size, the prediction matrix, and the number of observation bits. For an n-bit scrambler LFSR, the prediction matrix may be an n on n binary matrix, requiring at least n observation bits to uniquely determine the future state. The known spacing between consecutive observation bits may be incorporated into the offline computation of the prediction matrix, enabling efficient reconstruction from the sparse observations.

The method may further include collecting the first subset of bits into the observation vector, performing binary matrix multiplication of the observation vector with the binary prediction matrix to compute the future state, waiting until a predetermined time corresponding to when the scrambler reaches the computed future state, loading the computed future state into a descrambler at the receiver at the predetermined time, and initiating descrambler operation synchronized with the scrambler. The method may implement a sequence of operations for establishing synchronization using the deterministic prediction approach. After collecting all observation bits into a vector, the receiver may perform the binary matrix multiplication to compute the future state. The method may include a waiting period until the moment when the transmitter's scrambler reaches the computed state, at which point the receiver loads this state into its descrambler. This coordinated timing may ensure that the descrambler begins operation in synchronization with the scrambler, without requiring iterative synchronization algorithms or state search procedures.

The following numbered embodiments are non-limiting embodiments that may be combined with other compatible embodiments described herein and/or may be combined with, or refer to, any compatible claims.
1. In one embodiment, system, comprising: a transmitter comprising a scrambler that utilizes a linear feedback shift register (LFSR) that shifts at a constant rate, wherein the transmitter is configured to selectively transmit a first subset of bits from the scrambler during an initial synchronization phase; a receiver configured to: receive the first subset of bits, reconstruct a state of the LFSR in the scrambler based on the first subset of bits, and establish synchronization between a descrambler at the receiver and the scrambler based on the reconstructed state; and wherein the transmitter is further configured to increase data throughput by transmitting a second subset of bits from the scrambler while maintaining the constant rate; wherein the second subset comprises more bits than the first subset; and wherein the receiver is further configured to process the increased data throughput while maintaining synchronization between the descrambler and the scrambler.
2. The system of embodiment 1, wherein the reconstructed state is a future state of the LFSR, and wherein the receiver reconstructs the state by applying a pre-computed binary prediction matrix to an observation vector comprising the first subset of bits, wherein the binary prediction matrix is computed offline based on a generator polynomial of the LFSR and a pattern of the first subset of bits.
3. The system of embodiment 2, wherein for an n-bit LFSR, the binary prediction matrix comprises n on n binary values, and wherein the first subset of bits comprises at least n observation bits with known spacing between consecutive observation bits; and wherein the future state corresponds to an LFSR state at a predetermined number of LFSR steps after a last bit of the first subset of bits is received, wherein the predetermined number of LFSR steps accounts for computation time required to perform binary matrix multiplication.
4. The system of any one of embodiments 1-3, wherein the receiver is further configured to verify successful synchronization by comparing a sequence of predicted bits generated by the descrambler with corresponding received bits from the first subset of bits transmitted by the transmitter, and optionally to calculate and monitor multiple synchronization quality metrics including at least: a bit prediction accuracy rate, a phase alignment stability measure, and an LFSR state confidence score; and wherein decisions to proceed with throughput increases are based on these metrics meeting predetermined thresholds.
5. The system of any one of embodiments 1-4, wherein the first subset of bits is selected according to at least one of: periodic selection of every Nth bit generated by the scrambler, position-based selection of bits at predetermined positions in the scrambler output sequence, or pattern-based selection where bits are selected according to a predetermined pattern.
6. The system of any one of embodiments 1-5, wherein the receiver further comprises equalizers and cancellers, and the receiver is further configured to train the equalizers and cancellers utilizing the synchronization between the descrambler and the scrambler to predict incoming transmitter symbols; and optionally wherein training the equalizers and cancellers comprises using a sequence generated by the LFSR in the descrambler or its inverse as a reference pattern for direct error computation and parameter adaptation.
7. The system of any one of embodiments 1-6, wherein the transmitter is configured to transmit the first subset of bits over a single lane during the initial synchronization phase, and wherein increasing the data throughput comprises the transmitter distributing bits from the scrambler across multiple lanes, and wherein the receiver is configured to maintain the established synchronization across the multiple lanes.
8. The system of embodiment 7, wherein the receiver is further configured to at least one of: (a) verify successful synchronization across the multiple lanes by predicting expected received bits for each lane based on the established synchronization and comparing the predicted bits with received bits on each respective lane; or (b) train inter-lane crosstalk cancellers by: isolating crosstalk interference patterns between lanes using predicted data sequence for each lane, calculating a crosstalk transfer function between adjacent lanes, adaptively updating crosstalk cancellation coefficients based on the crosstalk transfer function, and verifying cancellation performance using a sequence generated by the LFSR in the descrambler as a reference.
9. The system of any one of embodiments 1-8, wherein upon failing to verify successful synchronization, the receiver is configured to: signal the synchronization failure to the transmitter, reset its descrambler to an initialization state, and restart the synchronization process with adjusted equalization and timing recovery parameters; wherein the transmitter is configured to respond to the synchronization failure signal by resetting its scrambler to a predetermined state.
10. The system of any one of embodiments 1-9, wherein the receiver further comprises a non-linear filter comprising at least one of: a decision feedback equalizer with adaptively trained feedback coefficients, a non-linear filter with dynamically adjusted kernel coefficients, or a neural network with multiple layers; and wherein the receiver is further configured to train the non-linear filter based on: providing received symbols as inputs to the non-linear filter, comparing outputs of the non-linear filter with expected symbols derived from a sequence generated by the LFSR in the descrambler to generate error signals, and adjusting parameters of the non-linear filter using a gradient-based optimization algorithm to minimize the error signals.
11. The system of embodiment 5, wherein the scrambler receives either all-zero input data or all-one input data during the initial synchronization phase, resulting in the first subset of bits corresponding to either a predetermined LFSR sequence or its inverse, respectively, and wherein the receiver reconstructs the state of the LFSR by comparing the received first subset of bits with expected values of the predetermined LFSR sequence or its inverse; and optionally wherein the transmitter continues to input the same all-zero input data or all-one input data to the scrambler when transmitting the second subset of bits.
12. In one embodiment, method, comprising: operating a scrambler at a transmitter at a constant shift rate; transmitting a first subset of bits generated by the scrambler during an initial synchronization phase; establishing, at a receiver, synchronization with the scrambler based on the first subset of bits; increasing data throughput by transmitting a second subset of bits from the scrambler while maintaining the constant shift rate, wherein the second subset comprises more bits than the first subset; and processing the increased data throughput at the receiver while maintaining the established synchronization.
13. The method of embodiment 12, wherein establishing synchronization comprises reconstructing a future state of the scrambler by applying a pre-computed binary prediction matrix to an observation vector comprising the first subset of bits, wherein the binary prediction matrix is computed offline based on a generator polynomial of the scrambler and a pattern of the first subset of bits.
14. The method of any one of embodiments 12-13, further comprising at least one of: (a) maintaining transmission of the second subset of bits for a predetermined stabilization period after increasing the data throughput, monitoring receiver performance metrics during the stabilization period, and transitioning to processing arbitrary input data after determining stable operation; or (b) transmitting the first subset of bits using a first modulation scheme, and transmitting the second subset of bits using a second modulation scheme that encodes more bits per symbol than the first modulation scheme.
15. The method of any one of embodiments 12-14, further comprising at least one of: (a) verifying successful synchronization by comparing a predetermined number of predicted bits generated by a descrambler at the receiver with corresponding received bits, wherein the predetermined number of bits exceeds a length of an LFSR implemented in the scrambler; or (b) training a non-linear filter at the receiver during the initial synchronization phase using the first subset of bits as a training reference, and continuing to train the non-linear filter during increased data throughput using a synchronized descrambler to predict incoming bits.
16. The method of any one of embodiments 12-15, further comprising: evaluating, at the receiver, a synchronization accuracy level; signaling, from the receiver to the transmitter, a readiness indication when the synchronization accuracy level exceeds a predetermined threshold; and increasing the data throughput by transmitting the second subset of bits after the transmitter receives the readiness indication.
17. The method of any one of embodiments 12-16, further comprising: transmitting the first subset of bits over a single lane during the initial synchronization phase; distributing the second subset of bits across multiple lanes during the increased data throughput phase; and maintaining the established synchronization across the multiple lanes by using a single descrambler at the receiver to process bits from all lanes based on knowledge of how bits are distributed.

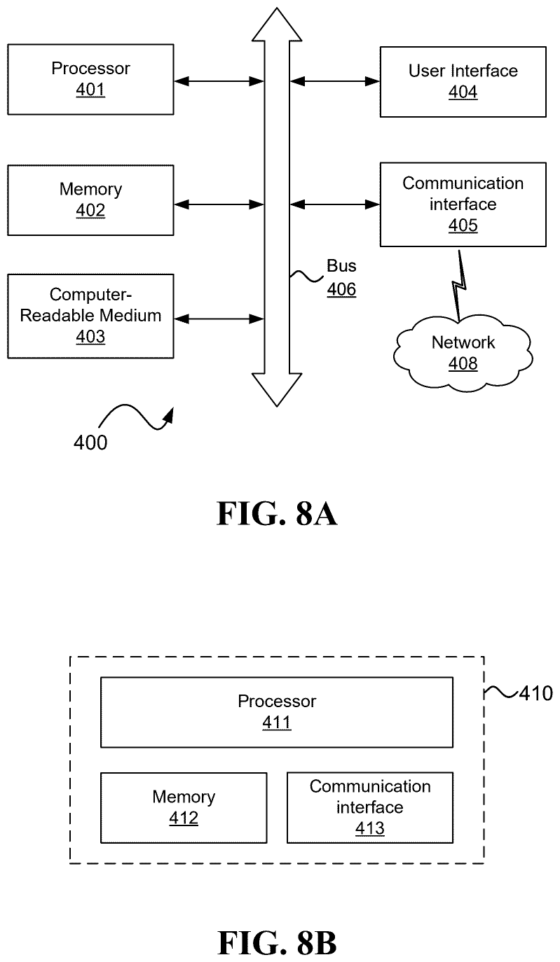

FIG. 8A and FIG. 8B are schematic illustrations of possible additional or alternative embodiments of computers (400, 410) that are able to realize one or more of the embodiments discussed herein that include a “computer” and/or a “processor” coupled to a memory and a communication interface. The computer (400, 410) may be implemented in various ways, such as, but not limited to, a microcontroller, a computer on a chip, a system-on-chip (SoC), a system-on-module, a processor with its required peripherals, a server computer, a client computer, a personal computer, a cloud computer, a network device, a communication device, a handheld device, a wearable device, and/or any other computer form capable of executing a set of computer instructions. Further, references to a computer or a processor include any collection of one or more computers and/or processors (which may be at different locations) that individually or jointly execute one or more sets of computer instructions. This means that the singular term “computer” is intended to imply one or more computers, which jointly perform the functions attributed to “the computer”. The computer 400 includes one or more of the following components: processor 401, memory 402, computer readable medium 403, user interface 404, communication interface 405, and bus 406. The computer 410 includes one or more of the following components: processor 411, memory 412, and communication interface 413.

The number, order, timings, dimensions, connections, and other properties of the elements illustrated in the drawings are non-limiting examples. Depending on the context, each element (such as lines, arrows, boxes, blocks, symbols, or labels) illustrated in the drawings may represent one or more actual elements. For example, a single box in a block diagram may represent multiple hardware components or software modules, a single arrow in a flowchart may represent multiple process steps or data transfers, and a single line in a circuit diagram may represent multiple electrical connections. Additionally, depending on the context, various nuances, modifications, flexibilities, and/or alternatives may be applied to certain relevant elements of the drawings herein.

The methods, algorithms, logics, processes, operations, and system functions described throughout this disclosure are not limited by a particular order, timing, sequence, grouping, or a specific embodiment described or illustrated unless expressly stated otherwise. Steps, operations, and functions may be performed in any reasonable order, simultaneously or sequentially, in parallel or series, and may be combined, separated, modified, rearranged, omitted, or supplemented based on particular embodiment requirements. Any process descriptions, steps, or blocks in flowcharts or other illustrations should be understood as potentially representing modules, segments, portions of code, or operations that may be executed in any reasonable order, combination, or concurrently, and are not necessarily limited to the particular sequence depicted. Alternative embodiments and variations are contemplated wherein functional operations may be executed in different orders, segmented differently, combined, distributed across multiple systems or components, or modified according to implementation-specific requirements. The disclosed embodiments can be implemented using various hardware configurations, software architectures, programming languages, data structures, communication protocols, and storage mechanisms, and substitutions, modifications, and alternatives will be apparent to those skilled in the art.

References to “one embodiment”, along with its variations like “aspect” or “case”, indicate that the described features may be present in one or more embodiments. Additionally, distinct references to embodiments, including terms like “one embodiment”, “another embodiment”, or “some embodiments”, do not necessarily denote separate embodiments. They may describe the same embodiment from different perspectives, highlight various aspects of a single embodiment, or pertain to distinct embodiments. Moreover, all references to terms such as ‘example’ and ‘instance’ are to be understood as non-limiting examples and non-limiting instances. Furthermore, in this disclosure, all uses of “herein” in the context of term definitions shall be understood to mean throughout this disclosure, including all embodiments and examples described herein.

Sentences in the form of “X is indicative of Y” mean that X includes information correlated with Y and/or describing Y, up to the case where X equals Y. Sentences in the form of “provide/receive an indication (of whether X happened)” may refer to any indication method. The word “most” of something is defined as above 51% of the something (including 100% of the something). The words “portion”, “subset”, “region”, and “area” of something refer to a value between a non-zero fraction of the something and 100% of the something, inclusive. “Coupled” indicates direct or indirect cooperation and/or interaction, such as direct or indirect physical contact, electrical connection, and/or software and/or hardware interface. The use of “a” or “an” refers to one or more things. The phrase “based on” indicates an open-ended claim language, and is to be interpreted as “based, at least in part, on”. Additionally, stating that a value is calculated “based on X” and following that, in a certain embodiment, that the value is calculated “also based on Y”, means that in the certain embodiment, the value is calculated based on X and Y. Variations of the terms “utilize” and “use” indicate an open-ended claim language, such that sentences in the form of “detecting X utilizing Y” are intended to mean “detecting X utilizing at least Y”, and sentences in the form of “use X to calculate Y” are intended to mean “calculate Y based on X”.

The terms “first”, “second” and so forth are to be interpreted merely as ordinal designations, and shall not be limited in themselves. A predetermined, predefined, or preselected value is a fixed value and/or a value determined any time before performing a calculation that utilizes the predetermined value. When appropriate, the word “value” may indicate a “predetermined value”. The word “threshold” indicates a “predetermined threshold”, which means that the value of the threshold, and/or the logic used to determine whether the threshold is reached, is known before start performing computations to determine whether the threshold is reached.

Herein, the terms “send”, “sending”, “receive”, “receiving”, “communicate”, “communication”, “communicating”, “exchange”, and “exchanging”, when used to describe elements (e.g., port, interface, computer, system) involved in data, message, packet, or other information exchanges, may refer to any direct or indirect operation(s) that facilitate information transfer to/from/between elements. The sending element is not required to directly transmit the information, nor is the receiving element required to directly obtain the information; instead, they may initiate, cause, control, direct, participate in, or otherwise facilitate the transfer. Such information transfer may occur directly or indirectly through one or more intermediary components, and may include routing, forwarding, or other data transfer mechanisms over any suitable communication path and/or connection.

The embodiments of an invention may include any variety of combinations and/or integrations of the features of the embodiments described herein. Although some embodiments may describe serial operations, the embodiments may perform certain operations in parallel and/or in different orders from those described. Moreover, the use of repeated reference numerals and/or letters in the text and/or drawings is for the purpose of simplicity and clarity and does not in itself dictate a relationship between the various embodiments and/or configurations discussed. Components and/or modules referred to by different reference numerals may or may not perform the same (or similar) functionality, and the fact they are referred to by different reference numerals and/or letters does not mean that they may not have same or similar functionalities.

Certain features of the embodiments, which may have been, for clarity, described in the context of separate embodiments, may also be provided in various combinations in a single embodiment. Conversely, various features of the embodiments, which may have been, for brevity, described in the context of a single embodiment, may also be provided separately or in any suitable sub-combination. Embodiments described in conjunction with specific examples are presented by way of example, and not limitation. Moreover, it is evident that many alternatives, modifications, and variations will be apparent to those skilled in the art. It is to be understood that other embodiments may be utilized and structural changes may be made without departing from the scope of the embodiments.

The drawings depict some, but not necessarily all, the couplings between elements. The depiction of elements as separate entities may be done to emphasize different functionalities of elements that may be implemented by the same software and/or hardware. Programs and/or elements illustrated and/or described as being single may be implemented via multiple programs and/or involve multiple hardware elements possibly in different locations. The embodiments are not limited in their applications to the details of order, or sequence of method steps, or to details of implementation of the devices, set in the description, drawings, or examples. Individual blocks illustrated in the drawings may be functional in nature and therefore may not necessarily correspond to discrete hardware elements. Moreover, the organization of this disclosure into sections, potentially titled, aims to enhance readability without constraining the scope, allowing for the integration of elements, features, components, and steps across various sections.

Accordingly, this disclosure is intended to embrace all such alternatives, modifications, and variations that fall within the spirit and scope of the appended claims and their equivalents.

What is claimed is:

1. A method for communication link training, comprising:
generating and transmitting symbols representing a first scrambled sequence resulting from shifting a scrambler, at a first transceiver, at a first rate, wherein the first scrambled sequence is generated by inputting either all-zero input data or all-one input data to the scrambler, resulting in either a predetermined sequence or its inverse, respectively;
establishing a descrambler lock, at a second transceiver, based on synchronizing the descrambler's state with the scrambler's state utilizing the symbols representing the first scrambled sequence;
coordinating an increase of the first rate to a second rate in a manner that preserves the descrambler lock;
generating and transmitting symbols representing a second scrambled sequence resulting from shifting the scrambler at the second rate; and
training respective equalizers and cancellers of the second transceiver based on prediction of the second scrambled sequence by the locked descrambler.

2. The method of claim 1, wherein the generating and transmitting symbols comprises transmitting the symbols over a single lane both before and after increasing from the first rate to the second rate; wherein transmitting at the first rate corresponds to transmitting symbols at a first symbol rate and transmitting at the second rate corresponds to transmitting symbols at a second symbol rate; wherein the descrambler lock is maintained on the single lane during and after the increase from the first rate to the second rate; and wherein the first rate and the first symbol rate are at least 4 times, 16 times, 32 times, 64 times, or 128 times slower than the second rate and the second symbol rate, respectively.

3. The method of claim 1, wherein the generating and transmitting symbols representing the first scrambled sequence comprises transmitting the symbols over a single lane at the first rate which corresponds to a first symbol rate, and wherein the generating and transmitting symbols representing the second scrambled sequence comprises transmitting the symbols over multiple lanes at the second rate which corresponds to a second symbol rate; wherein the first symbol rate is at least 4 times, 16 times, 32 times, 64 times, or 128 times slower than the second symbol rate; and further comprising training inter-lane crosstalk cancellers at the second transceiver based on prediction of the second scrambled sequence while maintaining the descrambler lock.

4. The method of claim 1, wherein establishing the descrambler lock comprises:
inputting a predetermined data pattern to the scrambler, receiving the first scrambled sequence at the second transceiver, and determining the scrambler's state by comparing the received first scrambled sequence with expected scrambled values of the predetermined data pattern.

5. The method of claim 4, wherein coordinating the increase of the first rate to the second rate comprises continuing to input the same predetermined data pattern to the scrambler at the second rate.

6. The method of claim 1, wherein establishing the descrambler lock comprises:
inputting either all-zero input data or all-one input data to the scrambler, receiving the first scrambled sequence at the second transceiver, and determining the scrambler's state by comparing the received first scrambled sequence with expected scrambled values corresponding to either a predetermined sequence or its inverse, respectively.

7. The method of claim 6, wherein coordinating the increase of the first rate to the second rate comprises continuing to input the same all-zero input data or all-one input data to the scrambler at the second rate.

8. The method of claim 1, wherein establishing the descrambler lock comprises:
transmitting current contents of the scrambler's feedback shift register to the second transceiver, receiving the feedback shift register contents at the second transceiver, and determining the scrambler's state based on the received feedback shift register contents.

9. The method of claim 8, wherein coordinating the increase of the first rate to the second rate comprises transmitting updated register contents after increasing to the second rate.

10. The method of claim 1, wherein both the first and second scrambled sequences are generated utilizing the same training pattern as input to the scrambler.

11. The method of claim 1, wherein the first scrambled sequence is generated utilizing a first training pattern as input to the scrambler, the second scrambled sequence is generated utilizing a second training pattern as input to the scrambler, and wherein transition from the first training pattern to the second training pattern is predefined to occur in coordination with the increase of the first rate to the second rate.

12. The method of claim 1, further comprising: training a non-linear filter at the second transceiver based on symbols received at the second rate while utilizing the locked descrambler for decoding the symbols during the training of the non-linear filter, wherein training the non-linear filter comprises: providing symbols decoded using the locked descrambler as input to the non-linear filter, comparing an output of the non-linear filter to a known sequence to generate an error signal, and adjusting parameters of the non-linear filter based on the error signal.

13. The method of claim 12, wherein training the non-linear filter comprises training the non-linear filter using symbols received at the second rate without first training the non-linear filter using symbols received at the first rate.

14. A system, comprising:
a first transceiver comprising a scrambler configured to:
generate a first scrambled sequence by shifting the scrambler at a first rate, wherein the first scrambled sequence is generated by inputting either all-zero input data or all-one input data to the scrambler, resulting in either a predetermined sequence or its inverse, respectively, and
transmit symbols representing the first scrambled sequence;
a second transceiver comprising a descrambler, equalizers, and cancellers, wherein the second transceiver is configured to establish a descrambler lock based on synchronizing the descrambler's state with the scrambler's state utilizing the symbols representing the first scrambled sequence;
wherein the first transceiver and the second transceiver are configured to coordinate an increase of the first rate to a second rate in a manner that preserves the descrambler lock;
wherein the first transceiver is further configured to generate and transmit symbols representing a second scrambled sequence resulting from shifting the scrambler at the second rate; and
wherein the second transceiver is further configured to train the equalizers and cancellers based on prediction of the second scrambled sequence by the locked descrambler.

15. The system of claim 14, wherein the first transceiver is configured to transmit the symbols over a single lane both before and after increasing from the first rate to the second rate; wherein transmitting at the first rate corresponds to transmitting symbols at a first symbol rate and transmitting at the second rate corresponds to transmitting symbols at a second symbol rate; wherein the second transceiver is configured to maintain the descrambler lock on the single lane during and after the increase from the first rate to the second rate; and wherein the first rate and the first symbol rate are at least 4 times, 16 times, 32 times, 64 times, or 128 times slower than the second rate and the second symbol rate, respectively.

16. The system of claim 14, wherein the first transceiver is configured to transmit the symbols representing the first scrambled sequence over a single lane at the first rate which corresponds to a first symbol rate and to transmit the symbols representing the second scrambled sequence over multiple lanes at the second rate which corresponds to a second symbol rate; wherein the first symbol rate is at least 4 times, 16 times, 32 times, 64 times, or 128 times slower than the second symbol rate; and wherein the second transceiver is further configured to train inter-lane crosstalk cancellers based on prediction of the second scrambled sequence while maintaining the descrambler lock.

17. A method for multi-lane communication link training, comprising:
generating symbols representing a first scrambled sequence resulting from shifting a scrambler at a first transceiver at a first rate, wherein the first scrambled sequence is generated by inputting either all-zero input data or all-one input data to the scrambler, resulting in either a predetermined sequence or its inverse, respectively;
transmitting, according to a first modulation and over a single lane, a first symbol stream representing the first scrambled sequence;
establishing a descrambler lock, at a second transceiver, based on synchronizing the descrambler's state with the scrambler's state utilizing the symbols representing the first scrambled sequence;
coordinating an increase of the first rate to a second rate in a manner that preserves the descrambler lock;
generating symbols representing a second scrambled sequence resulting from shifting the scrambler at the second rate;
transmitting, according to a second modulation and over multiple lanes, the symbols representing the second scrambled sequence; and
training respective equalizers, cancellers, and inter-lane crosstalk cancellers of the second transceiver based on predictions of the second scrambled sequence by the locked descrambler.

18. The method of claim 17, further comprising verifying successful transition to the second modulation by comparing predicted symbols with received symbols across each of the multiple lanes for at least a predetermined number of symbols.

19. The method of claim 17, further comprising verifying correct distribution of the scrambled sequence across the multiple lanes by comparing predicted symbol patterns with received symbol patterns on each lane.

20. The method of claim 17, wherein transmitting over multiple lanes comprises progressively activating individual lanes while maintaining the descrambler lock, and verifying successful activation of each lane before activating a subsequent lane.

21. The method of claim 17, wherein the first modulation comprises a first modulation scheme operating at a first symbol rate, the second modulation comprises a higher-level modulation scheme operating at a second symbol rate, and the first rate is at least 4 times, 16 times, 32 times, 64 times, or 128 times slower than the second rate; and wherein the first symbol rate is at least 4 times, 16 times, 32 times, 64 times, or 128 times slower than the second symbol rate.

22. The method of claim 17, wherein the coordinating of the increase of the first rate to the second rate comprises: monitoring channel conditions on each lane, selecting the second modulation based on the monitored channel conditions, and coordinating transition to the second modulation with both the rate increase and transition to multiple lanes.

23. The method of claim 17, further comprising: training a non-linear filter at the second transceiver based on symbols received at the second rate while utilizing the locked descrambler for decoding the symbols during the training of the non-linear filter, wherein training the non-linear filter comprises: providing symbols decoded using the locked descrambler as input to the non-linear filter, comparing an output of the non-linear filter to a known sequence to generate an error signal, and adjusting parameters of the non-linear filter based on the error signal.

24. The method of claim 23, wherein training the non-linear filter comprises training the non-linear filter using symbols received at the second rate without first training the non-linear filter using symbols received at the first rate.

25. A system for multi-lane communication link training, comprising:
a first transceiver comprising a scrambler configured to:
generate symbols representing a first scrambled sequence by shifting the scrambler at a first rate, wherein the first scrambled sequence is generated by inputting either all-zero input data or all-one input data to the scrambler, resulting in either a predetermined sequence or its inverse, respectively, and
transmit, according to a first modulation and over a single lane, a first symbol stream representing the first scrambled sequence;
a second transceiver comprising a descrambler, equalizers, cancellers, and inter-lane crosstalk cancellers, wherein the second transceiver is configured to establish a descrambler lock based on synchronizing the descrambler's state with the scrambler's state utilizing the symbols representing the first scrambled sequence;
wherein the first transceiver and the second transceiver are configured to coordinate an increase of the first rate to a second rate in a manner that preserves the descrambler lock;
wherein the first transceiver is further configured to: generate symbols representing a second scrambled sequence resulting from shifting the scrambler at the second rate, and transmit, according to a second modulation and over multiple lanes, the symbols representing the second scrambled sequence; and
wherein the second transceiver is further configured to train the equalizers, cancellers, and inter-lane crosstalk cancellers based on predictions of the second scrambled sequence by the locked descrambler.

26. The system of claim 25, wherein the second transceiver is further configured to verify successful transition to the second modulation by comparing predicted symbols with received symbols across each of the multiple lanes for at least a predetermined number of symbols.

27. The system of claim 25, wherein the first modulation comprises a first modulation scheme operating at a first symbol rate, the second modulation comprises a higher-level modulation scheme operating at a second symbol rate, and the first rate is at least 4 times, 16 times, 32 times, 64 times, or 128 times slower than the second rate; and wherein the first symbol rate is at least 4 times, 16 times, 32 times, 64 times, or 128 times slower than the second symbol rate.

28. The system of claim 25, wherein the second transceiver further comprises a non-linear filter; and the second transceiver is further configured to train the non-linear filter based on symbols received at the second rate while utilizing the locked descrambler for decoding the symbols during the training of the non-linear filter, wherein training the non-linear filter comprises: providing symbols decoded using the locked descrambler as input to the non-linear filter, comparing an output of the non-linear filter to a known sequence to generate an error signal, and adjusting parameters of the non-linear filter based on the error signal.
